(19) United States
(12) Patent Application Publication
(10) Pub. No.: US 2025/0299444 A1
(43) Pub. Date: Sep. 25, 2025

(54) TRAJECTORY INFORMATION PROCESSING METHOD AND APPARATUS, COMPUTER DEVICE, AND READABLE STORAGE MEDIUM

(71) Applicant: TENCENT TECHNOLOGY (SHENZHEN) COMPANY LIMITED, Shenzhen (CN)

(72) Inventors: Zelin YE, Shenzhen (CN); Xiya JIA, Shenzhen (CN); Xinghui FU, Shenzhen (CN); Zhongqian SUN, Shenzhen (CN)

(21) Appl. No.: 19/229,443

(22) Filed: Jun. 5, 2025

Related U.S. Application Data
(63) Continuation of application No. PCT/CN2024/079894, filed on Mar. 4, 2024.

(30) Foreign Application Priority Data
May 6, 2023 (CN) 202310501883.3

(51) Int. Cl. G06T 17/10; G06T 13/40

(52) U.S. Cl. CPC G06T 17/10; G06T 13/40; G06T 2210/21

(57) ABSTRACT

A trajectory information processing method includes: generating an object geometry of a first object based on a body shape feature of the first object, the object geometry including a plurality of local geometries, and the local geometries surrounding at least one part of the first object; obtaining object trajectory information of a second object, and migrating the object trajectory information of the second object to the object geometry, to obtain object trajectory information of the object geometry; determining a plurality of collision points at which the local geometries collide during interaction, and determining collision occurrence positions of the plurality of collision points; performing position adjustment to obtain collision avoidance positions of the plurality of collision points; and correcting the object trajectory information of the object geometry based on the collision occurrence positions and the collision avoidance positions, to obtain object trajectory information of the first object.

### CROSS-REFERENCES TO RELATED APPLICATIONS

This application is a continuation of PCT Application No. PCT/CN2024/079894, filed on Mar. 4, 2024, which claims priority to Chinese Patent Application No. 2023105018833, filed on May 6, 2023, and entitled “TRAJECTORY INFORMATION PROCESSING METHOD AND APPARATUS, COMPUTER DEVICE, AND READABLE STORAGE MEDIUM”, the entire contents of all of which are incorporated herein by reference.

### FIELD OF THE TECHNOLOGY

The present disclosure relates to the field of computer technologies, and in particular, to a trajectory information method and apparatus, a computer device, and a computer-readable storage medium.

### BACKGROUND OF THE DISCLOSURE

With the development of computer technologies, an animation retargeting technology emerges. Animation retargeting is the process of migrating an existing animation resource to a new character, to improve animation production efficiency. For example, an animation sequence of a character A is migrated to a character B, eliminating the need to create an entirely new animation for each character.

Some animation retargeting technologies mainly focus on differences between bones of characters, for example, differences between bone topologies and bone ratios of the two characters, based on which position and rotation information of each bone is calculated, thereby obtaining target animations of the characters.

However, as different characters have differences in aspects such as height, weight, and bust/waist/hip measurements, the animation obtained through migration by considering only the differences between the bones of the characters cannot match characteristics of the character.

### SUMMARY

According to embodiments provided in the present disclosure, a trajectory information processing method and apparatus, a computer device, a computer-readable storage medium, and a computer program product are provided.

According to an aspect, the present disclosure provides a trajectory information processing method, performed by a computer device. The method includes: obtaining a body shape feature of a first object, and generating an object geometry of the first object based on the body shape feature, the object geometry including a plurality of local geometries, and each of the local geometries surrounding at least one part of the first object; obtaining object trajectory information of a second object, and migrating the object trajectory information of the second object to the object geometry, to obtain object trajectory information of the object geometry; determining a plurality of collision points at which the local geometries collide during interaction with each other, and determining respective collision occurrence positions of the plurality of collision points; performing position adjustment on the plurality of collision occurrence positions, to obtain respectively corresponding collision avoidance positions of the plurality of collision points, wherein when the collision points are located at respective collision avoidance positions, the plurality of local geometries do not collide during the interaction; and correcting the object trajectory information of the object geometry based on the collision occurrence positions and the collision avoidance positions, to obtain object trajectory information of the first object.

According to another aspect, the present disclosure further provides a trajectory information processing apparatus, including: a generation module, configured to obtain a body shape feature of a first object, and generate an object geometry of the first object based on the body shape feature, the object geometry including a plurality of local geometries, and the local geometries surrounding at least one part of the first object; a migration module, configured to obtain object trajectory information of a second object, and migrate the object trajectory information of the second object to the object geometry, to obtain object trajectory information of the object geometry; a determining module, configured to determine a plurality of collision points at which the local geometries collide during interaction with each other, and determine respective collision occurrence positions of the plurality of collision points; an adjustment module, configured to perform position adjustment on the plurality of collision occurrence positions, to obtain respectively corresponding collision avoidance positions of the plurality of collision points, the collision avoidance positions being configured for avoiding collision of the plurality of local geometries during the interaction; and a correction module, configured to correct object trajectory information of the object geometry based on the collision occurrence positions and the collision avoidance positions, to obtain object trajectory information of the first object.

According to another aspect, the present disclosure further provides a computer device, the computer device including a memory and a processor, the memory having computer-readable instructions stored therein, and the processor, when executing the computer-readable instructions, performing the operations in the method embodiments of the present disclosure.

According to another aspect, the present disclosure further provides a non-transitory computer-readable storage medium, the computer-readable storage medium having computer-readable instructions stored therein, the computer-readable instructions, when executed by a processor, performing the operations in the method embodiments of the present disclosure.

Details of one or more embodiments of the present disclosure are provided in the accompany drawings and descriptions below. Other features and advantages of the present disclosure become apparent with reference to the specification, the accompanying drawings, and the claims.

### BRIEF DESCRIPTION OF THE DRAWINGS

FIG. 1 is a diagram of an application environment of a trajectory information processing method according to an embodiment.

FIG. 2 is a schematic flowchart of a trajectory information processing method according to an embodiment.

FIG. 3 is a schematic diagram of a global geometry construction according to an embodiment.

FIG. 4 is a schematic diagram of model interpenetration according to an embodiment.

FIG. 5 is a schematic diagram of local geometries colliding during interaction according to an embodiment.

FIG. 6 is a schematic flowchart of migrating object trajectory information of a second object to an object geometry, to obtain object trajectory information of the object geometry according to an embodiment.

FIG. 7 is a schematic diagram of a standard bone hierarchical relationship according to an embodiment.

FIG. 8 is a schematic diagram of local geometries colliding during interaction according to another embodiment.

FIG. 9 is a schematic flowchart of performing pose offset prediction based on collision occurrence positions and collision avoidance positions, to obtain pose offset information between a plurality of local geometries according to an embodiment.

FIG. 10 is a schematic diagram of pose matching according to an embodiment.

FIG. 11 is a schematic flowchart of a trajectory information processing method according to another embodiment.

FIG. 12 is a schematic diagram of model information of a character according to an embodiment.

FIG. 13 is a schematic diagram of matching of some bones according to an embodiment.

FIG. 14 is a structural block diagram of a trajectory information processing apparatus according to an embodiment.

FIG. 15 is a diagram of an internal structure of a computer device according to an embodiment.

### DESCRIPTION OF EMBODIMENTS

The technical solutions of the embodiments of the present disclosure are described below clearly and comprehensively with reference to the accompanying drawings of the embodiments of the present disclosure. Apparently, the embodiments described are merely some rather than all of the embodiments of the present disclosure. Based on the embodiments of the present disclosure, all other embodiments obtained by a person of ordinary skill in the art without creative efforts shall fall within the protection scope of the present disclosure.

The embodiments of the present disclosure may be applied to various scenarios, including, but not limited to, a cloud technology, artificial intelligence, smart transportation, assisted driving, and the like, for example, may be applied to the field of artificial intelligence (AI) technologies. The AI is a theory, a method, a technology, and an application system in which human intelligence is simulated and extended by using a digital computer or a machine controlled by a digital computer to perceive an environment, obtain knowledge, and achieve an optimal result by using the knowledge. In other words, the AI is a comprehensive technology in computer science. The artificial intelligence attempts to understand an essence of intelligence, and produces a new intelligent machine that can react in a manner similar to the human intelligence. The AI is to study the design principles and implementation methods of various intelligent machines, to enable the machines to have the functions of perception, reasoning, and decision-making. The solutions provided in the embodiments of the present disclosure relate to an AI trajectory information processing method, which is specifically described by using the following embodiments.

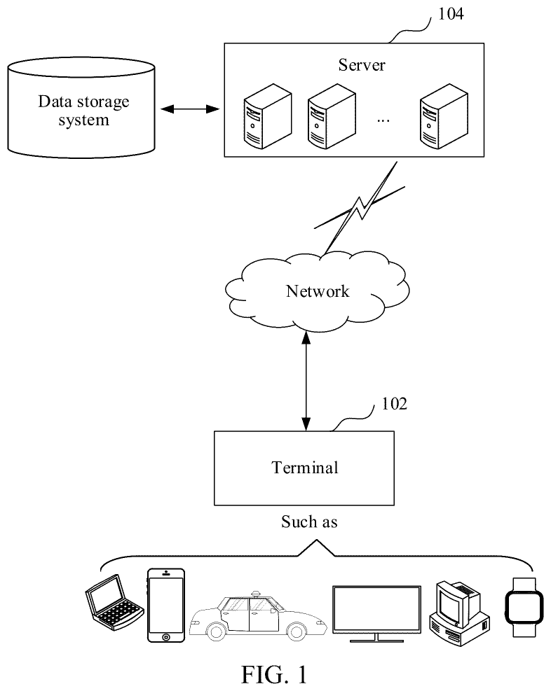

The trajectory information processing method provided in the embodiments of the present disclosure may be applied to an application environment shown in FIG. 1. A terminal 102 communicates with a server 104 through a network. A data storage system may store data that the server 104 needs to process. The data storage system may be integrated on the server 104, or may be placed on a cloud or another server. Both the terminal 102 and the server 104 can separately perform the trajectory information processing method provided in the embodiments of the present disclosure. The terminal 102 and the server 104 may alternatively be collaboratively configured to perform the trajectory information processing method provided in the embodiments of the present disclosure. When the terminal 102 and the server 104 are collaboratively configured to perform the trajectory information processing method provided in the embodiments of the present disclosure, a body shape feature of a first object and object trajectory information of a second object are obtained by the terminal 102 and sent to the server 104. The server 104 generates an object geometry of the first object based on the body shape feature. The object geometry includes a plurality of local geometries, and the local geometries surround at least one part of the first object. The server 104 migrates the object trajectory information of the second object to the object geometry, to obtain object trajectory information of the object geometry. The server 104 determines a plurality of collision points at which the local geometries collide during interaction with each other, and determines respective collision occurrence positions of the plurality of collision points. The server 104 performs position adjustment on the plurality of collision occurrence positions, to obtain the respective collision avoidance positions of the plurality of collision points. The collision avoidance positions are configured for avoiding collision of the plurality of local geometries during the interaction. The server 104 corrects the object trajectory information of the object geometry based on the collision occurrence positions and the collision avoidance positions, to obtain object trajectory information of the first object, and feeds back the object trajectory information of the first object to the terminal 102. The terminal 102 may be, but is not limited to, various desktop computers, notebook computers, smart phones, tablet computers, Internet of Things devices, and portable wearable devices. The Internet of Things device may be a smart speaker, a smart television, a smart air conditioner, a smart in-vehicle device, or the like. The portable wearable device may be a smart watch, a smart band, a head-mounted device, and the like. The server 104 may be implemented by using an independent server or a server cluster that includes a plurality of servers.

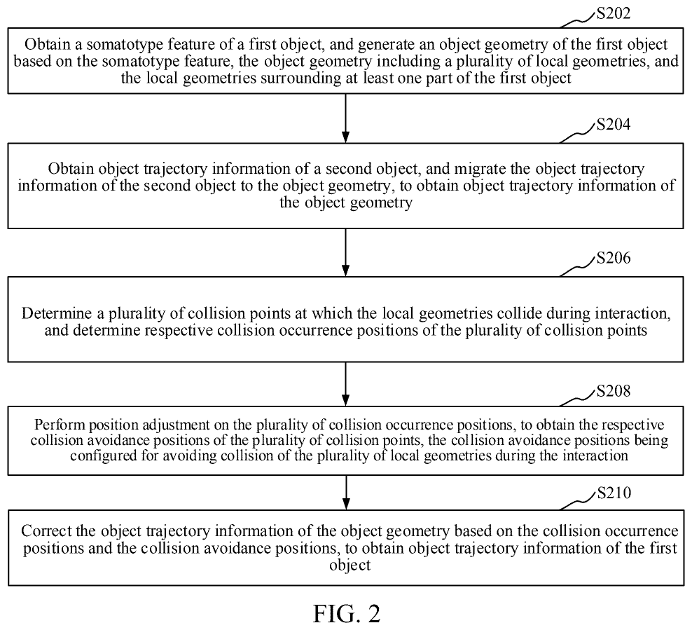

In an embodiment, as shown in FIG. 2, a trajectory information processing method is provided. An example in which the method is applied to the computer device in FIG. 1 (where the computer device may be the terminal or the server in FIG. 1) is used for description. The method includes the following operations.

Operation S202: Obtain a body shape feature of a first object, and generate an object geometry of the first object based on the body shape feature, the object geometry including a plurality of local geometries, and the local geometries surrounding at least one part of the first object.

The body shape feature is feature information related to a somatotype of the first object. The somatotype is general description and assessment of a body shape, and may be, for example, a ratio between parts of a human body.

The body shape feature may include at least one of the following: features of various parts of the body, a longitudinal ratio of the body, and a ratio of the torso to the limbs. The features of various parts of the body include, but are not limited to, a head feature, a shoulder feature, a limb feature, and an abdomen feature.

The first object includes a plurality of parts, and the plurality of parts may form a movable body. The plurality of parts includes parts forming the first object, for example, a head, a shoulder, a torso, and limbs, but is not limited thereto. The body of the first object includes a plurality of first limbs. The first limb may be, for example, an upper limb, a lower limb, a front limb, or a rear limb.

The local geometry is a geometry wrapping a local part of the first object, the local part of the first object is one or more parts of the first object, and a plurality of means at least two, for example, a local geometry surrounding a head of the first object, or a local geometry surrounding an upper limb of the first object, where the upper limb includes a plurality of parts such as an upper arm, a lower arm, a wrist, and a hand.

The object geometry is a global geometry formed by local geometries. In some other embodiments, the object geometry is a global geometry formed by local geometries surrounding each part of the first object, and the global geometry surrounds the first object.

The computer device may detect somatotype information of the first object, and extract the body shape feature of the first object from the somatotype information. The first object has a plurality of parts. The computer device generates a plurality of local geometries on the first object based on the body shape feature. Each local geometry surrounds at least one part of the first object, to obtain the object geometry of the first object.

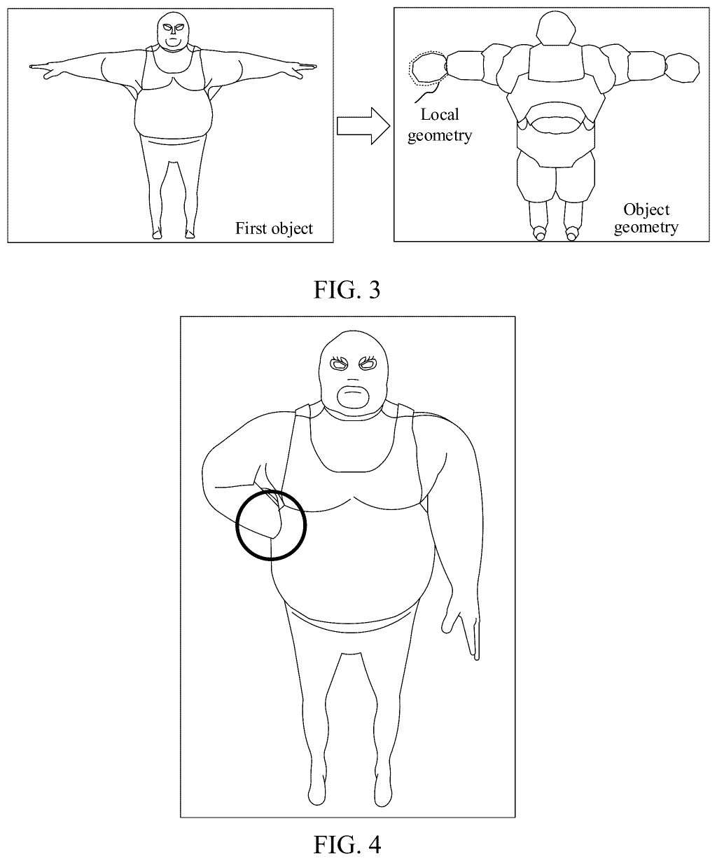

In this embodiment, the body shape feature includes a feature of each part of the first object. For each part, the computer device generates, at the part of the first object, a local geometry surrounding the part based on the feature of the part, to obtain local geometries surrounding parts of the first object. The local geometries can form the object geometry surrounding the first object. As shown in FIG. 3, a left upper limb of the first object includes a left upper arm, a left lower arm, a left wrist, and a left hand. A geometry surrounding the left upper arm, a geometry surrounding the left lower arm, a geometry surrounding the left wrist, and a local geometry surrounding the left hand are generated. According to similar processing, a local geometry is generated for each part of the first object, to form an object geometry surrounding the first object.

In this embodiment, the computer device generates a local geometry surrounding a plurality of parts, for example, generates a local geometry surrounding a left upper limb, and the local geometry surrounds a plurality of parts such as the left upper arm, the left lower arm, the left wrist, and the left hand.

In this embodiment, for a specific part of the first object, the computer device may generate, based on the body shape feature of the first object, local geometries including the specific part. Each local geometry forms a local geometry of the first object.

Operation S204: Obtain object trajectory information of a second object, and migrate the object trajectory information of the second object to the object geometry, to obtain object trajectory information of the object geometry.

The first object and the second object may be physical objects or virtual objects, and may be specifically physical model objects, virtual objects in a virtual scene, or the like, but is not limited thereto. The first object and the second object may be human objects or animal objects.

The first object and the second object belong to the same type of objects, for example, the first object is a human, and the second object is also a human. A quantity of parts of the first object may be the same as a quantity of parts of the second object. The parts of the first object are in a one-to-one correspondence with the parts of the second object.

The second object includes a plurality of parts, and the plurality of parts may form a movable body. The body of the second object includes a plurality of second limbs. The second limb may be, for example, an upper limb, a lower limb, a front limb, a rear limb, or the like. A quantity of the first limbs of the first object may be the same as a quantity of the second limbs of the second object.

The plurality of first limbs of the first object and the plurality of second limbs of the second object are in a one-to-one correspondence. For example, the left upper limb of the first object corresponds to the left upper limb of the second object, and the right upper limb of the first object corresponds to the right upper limb of the second object.

The object trajectory information of the second object is trajectory information corresponding to the second object, and may be specifically trajectory information formed by positions of the second object at different moments. The object trajectory information of the object geometry is rough trajectory information of the object geometry, and may be specifically trajectory information formed by rough positions of the object geometry at different moments. The position may be two-dimensional coordinates or three-dimensional coordinates.

The object trajectory information of the second object includes trajectory information of each of the parts of the second object. The object trajectory information of the object geometry includes initial trajectory information of the local geometries of the object geometry. Each local geometry in the object geometry surrounds at least one part of the first object. In other words, the initial trajectory information of the local geometry is used as initial trajectory information of the part surrounded by the local geometry. The object trajectory information of the object geometry is used as initial trajectory information of the first object.

The object trajectory information of the object geometry is rough trajectory information of the first object, and may be specifically initial trajectory information formed by rough positions of the first object at different moments.

In this embodiment, each local geometry in the object geometry surrounds at least one part of the first object, and the migrating the object trajectory information of the second object to the object geometry means migrating the object trajectory information of the second object to the first object, to obtain the initial trajectory information of the first object.

The computer device may obtain the object trajectory information of the second object, and migrate the object trajectory information of the second object to the first object, to represent that the object trajectory information of the second object is migrated to the object geometry, to obtain the object trajectory information of the object geometry.

In this embodiment, the object trajectory information of the second object includes trajectory information of the parts of the second object, and the object trajectory information of the object geometry includes initial trajectory information of the parts of the first object. The parts of the second object and the parts of the first object are in a one-to-one correspondence. The computer device migrates the trajectory information of the parts of the second object to corresponding parts of the first object, to obtain initial trajectory information of the corresponding parts of the first object, to obtain the object trajectory information of the object geometry.

Further, the parts of the second object and the parts of the second object are in a one-to-one correspondence, and the parts of the second object and the parts of the object geometry are in a one-to-one correspondence. For each part of the second object, the computer device replaces the trajectory information of the part with the initial trajectory information of the corresponding part in the object geometry, to obtain the object trajectory information of the object geometry.

In this embodiment, the computer device determines a matching relationship between the parts of the first object and the parts of the second object, and migrates the trajectory information of the parts of the second object to the corresponding parts of the first object based on the matching relationship, to obtain the initial trajectory information of the corresponding part of the first object, to obtain the object trajectory information of the object geometry.

In this embodiment, the object trajectory information of the second object includes joint rotation information and limb trajectory information of the second object. The computer device migrates the joint rotation information and the limb trajectory information of the second object to the object geometry, to obtain joint rotation information and limb trajectory information of the object geometry. The joint rotation information of the object geometry is initial joint rotation information of the first object, and the limb trajectory information of the object geometry is initial limb trajectory information of the first object.

In this embodiment, a body shape of the second object is smaller than a body shape of the first object, for example, the second object is thinner than the first object.

Operation S206: Determine a plurality of collision points at which the local geometries collide during interaction, and determine respective collision occurrence positions of the plurality of collision points.

The collision point is a point at which a plurality of local geometries collide, and a position of the collision point when the local geometries collide is a collision occurrence position of the collision point. Each of the plurality of local geometries includes at least one collision point.

In this embodiment, the collision point is a point on a surface of each of the plurality of local geometries when the local geometries collide.

After the object trajectory information of the second object is migrated to the object geometry, because there is a difference between the body shape of the first object and the body shape of the second object, when the parts of the first object interact based on the migrated object trajectory information of the second object, the parts that interact collide, that is, model interpenetration is generated. The model interpenetration is a situation in which a part of an object collides with another part of the object, causing the part to penetrate a surface of the another part, or the part to seriously press the surface of the another part, which does not conform to a normal interaction behavior between parts of the object.

For example, a difference between body shapes of an object A and an object B is large, the object A is thin, and the object B is fat. The object A may put a hand on the waist, and after object trajectory information of the object A is migrated to the object B, the object B wants to put a hand on the waist, but when an effect is presented, the hand of the object B is inserted into the waist, resulting in model interpenetration shown in FIG. 4.

The parts of the object geometry are the parts of the first object. For an object geometry having object trajectory information, the computer device controls, based on the object trajectory information, local geometries of the object geometry to interact with each other, to determine that there are a plurality of local geometries that collide during the interaction in the object geometry. For a plurality of local geometries that collide, the computer device determines a collision point on each local geometry when the plurality of local geometries collide, and determines a position of each collision point when the plurality of local geometries collide. The position of each collision point when the plurality of local geometries collide is used as a collision occurrence position of the collision point.

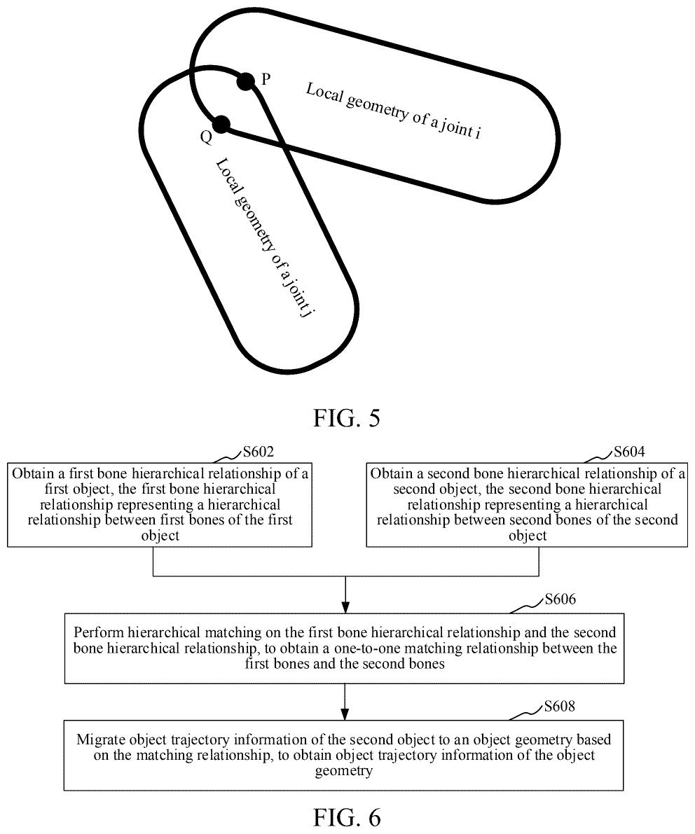

In this embodiment, the collision point may be a deepest collision point when a plurality of local geometries collide. As shown in FIG. 5, a part i and a part j of the first object collide. In other words, a local geometry to which the part i belongs and a local geometry to which the part j belongs collide, both the local geometry to which the part i belongs and the local geometry to which the part j belongs have a plurality of collision points, a deepest collision point on the local geometry to which the part i belongs is P, and a deepest collision point on the local geometry to which the part j belongs is Q.

The computer device may determine a deepest collision point on each local geometry when the plurality of local geometries collide, and determine a collision occurrence position of each deepest collision point.

Operation S208: Perform position adjustment on the plurality of collision occurrence positions, to obtain the respective collision avoidance positions of the plurality of collision points, the collision avoidance positions being configured for avoiding collision of the plurality of local geometries during the interaction.

The collision avoidance position is a position that can avoid collision, that is, a position that can evade collision. The collision avoidance positions are configured for avoiding collision of the plurality of local geometries during the interaction. When the collision points are located at respective collision avoidance positions, a plurality of local geometries do not collide during the interaction.

The computer device may perform position adjustment on the collision occurrence positions of the plurality of collision points, so that local geometries to which the plurality of collision points belong do not collide during the interaction, to obtain positions of the plurality of collision points in a case that the local geometries do not collide during the interaction. The positions of the plurality of collision points in the case that the local geometries do not collide during the interaction are used as the respective collision avoidance positions of the plurality of collision points.

In this embodiment, the collision point may be a deepest collision point when the plurality of local geometries collide, and the collision avoidance positions are positions of the plurality of collision points when the local geometries do not collide during the interaction. When a plurality of deepest collision points are located at respective collision avoidance positions, the plurality of deepest collision points no longer collide, and other collision points on each local geometry consequently do not collide, so that the plurality of local geometries do not collide during the interaction.

Operation S210: Correct the object trajectory information of the object geometry based on the collision occurrence positions and the collision avoidance positions, to obtain object trajectory information of the first object.

The object trajectory information of the first object is final trajectory information corresponding to the first object, and may be specifically trajectory information formed by final positions of the first object at different moments. The position may be two-dimensional coordinates or three-dimensional coordinates.

The computer device calculates, based on the collision occurrence positions and the collision avoidance positions, pose offset information when the plurality of local geometries do not collide. The computer device corrects the object trajectory information of the object geometry by using the pose offset information, to obtain the object trajectory information of the first object.

In this embodiment, the pose offset information includes joint rotation offset information of each of parts surrounded by a plurality of local geometries, and the object trajectory information of the object geometry includes joint rotation information of each of the parts surrounded by the plurality of local geometries. Joint rotation information of a part surrounded by a local geometry is corrected by using joint rotation offset information of the part surrounded by the local geometry, to obtain corrected joint rotation information. The object trajectory information of the first object includes the corrected joint rotation information.

In the trajectory information processing method, the body shape feature of the first object is obtained, and the object geometry of the first object is generated based on the body shape feature. The object geometry includes the plurality of local geometries, and the local geometries surround at least one part of the first object, so that the local geometry surrounding the part can fit the part, thereby enabling a generated object geometry to better fit the somatotype of the first object. The object trajectory information of the second object is obtained, and the object trajectory information of the second object is migrated to the object geometry, to obtain the object trajectory information of the object geometry, to preliminarily migrate the object trajectory information of the second object to the first object for subsequent adjustment. The plurality of collision points at which the local geometries of the object geometry collide during the interaction are determined, and the positions of the plurality of collision points, namely, the collision occurrence positions, are determined, to determine the position at which the local geometries collide during the interaction. The position adjustment is performed on the plurality of collision occurrence positions, to obtain the plurality of collision avoidance positions for avoiding the collision of the plurality of local geometries during the interaction, so that when the collision points are at the respective collision avoidance positions, the plurality of local geometries do not collide during the interaction. The object trajectory information of the object geometry is corrected based on the collision occurrence positions and the collision avoidance positions, so that after the correction, the parts of the first object do not collide during the interaction, to obtain the object trajectory information matching a somatotype characteristic of the first object. In addition, considering an impact of a somatotype of an object on migration of trajectory information, the migration of the trajectory information is more flexible and more accurate.

In an embodiment, the body shape feature is represented by a plurality of skinning key points of the first object, and the generating an object geometry of the first object based on the body shape feature includes:
obtaining respective skinning weights of the plurality of skinning key points; obtaining a preset weight constraint condition and selecting, based on the skinning weights, the skinning key point satisfying the weight constraint condition; performing principal component analysis on the selected skinning key point, to obtain respective geometric axes of a plurality of parts of the first object; and for each part of the plurality of parts, generating, based on a geometric axis of the part, a local geometry surrounding the part, to obtain the object geometry formed by the local geometries.

The body shape feature of the first object is represented by using a skinning key point of the first object. A technology of binding a model to a bone is referred to as skinning. Skinning is controlling a shape node of the model by using the bone, to achieve a proper binding effect, and the shape node is an external contour. The skinning is a producing technology of a three-dimensional animation, and refers to binding a grid point to a specified bone, and based on a weight allocated when the grid point is bound, the grid point moves with motion of the bone. The skinning key point is a key grid point and may be a grid vertex. A weight allocated when the grid point is bound is the skinning weight.

The principal component analysis (PCA) is for reducing a feature dimension and reducing information loss as much as possible.

The weight constraint condition is a preset constraint condition for filtering skinning key points based on weights, and may be specifically that the skinning weight of the skinning key point is greater than a preset weight threshold, or a preset quantity of skinning key points are selected in descending order of the skinning weights.

The computer device may obtain a plurality of skinning key points of the first object, to represent the body shape feature of the first object by using the plurality of skinning key points.

The computer device obtains respective skinning weights of the plurality of skinning key points of the first object, and obtains a preset weight constraint condition. The computer device performs matching on the skinning weight of each skinning key point with the weight constraint condition, to select a skinning key point satisfying the weight constraint condition from the plurality of skinning key points.

The computer device performs the principal component analysis on the selected skinning key point, to obtain axes corresponding to respective first principal components of the plurality of parts of the first object. For each part, the axis corresponding to the first principal component of the part is used as the geometric axis of the part.

For each of the plurality of parts, a local geometry surrounding the part is generated based on the geometric axis corresponding to the part, to obtain the respective local geometries of the plurality of parts. The local geometries of the plurality of parts form the object geometry of the first object.

In this embodiment, the skinning key points of the first object include a plurality of skinning key points of the plurality of parts of the first object.

For each of the plurality of parts of the first object, the computer device obtains a plurality of skinning key points of the part and determines a skinning weight corresponding to each skinning key point. For each of the plurality of parts, skinning the key point satisfying the weight constraint condition of the part based on the skinning weights corresponding to the plurality of skinning key points of the part. The principal component analysis is performed on the selected skinning key points to obtain the geometric axis of the part, based on the geometric axis of the part, a local geometry surrounding the part is generated, and the object geometry formed by the local geometries is obtained.

In this embodiment, the body shape feature of the first object is represented by the skinning key point of the first object, the respective skinning weights of the plurality of skinning key points of the first object are obtained, to select the skinning key point satisfying the weight constraint condition based on the skinning weights, and perform the principal component analysis on the selected skinning key points, to obtain the respective geometric axes of the plurality of parts of the first object. In this way, features close to the geometric axis can be reserved, a feature dimension can be reduced, a calculation amount can be reduced, and the information loss can be reduced. In addition, as many features as possible of the part are reserved by using the geometric axis, and the reserved features can better present a shape of the part. In this way, the local geometry surrounding the part generated based on the geometric axis of the part can fit the part, so that the object geometry formed by the obtained local geometries better fits the somatotype of the first object.

In an embodiment, the generating an object geometry of the first object based on the body shape feature includes:
obtaining a candidate geometric feature in each iteration, and for each iteration, generating a candidate geometry of the first object in the iteration based on the body shape feature and the candidate geometric feature of the iteration; determining a volume corresponding to the candidate geometry in each iteration; and obtaining a preset volume constraint condition, selecting a volume satisfying the volume constraint condition from the volumes, and determining the candidate geometry corresponding to the selected volume as the object geometry.

The candidate geometric feature is one or more types of three-dimensional geometric figures configured for generating the object geometry of the first object. For example, the object geometry is formed by combining a plurality of capsules, or the object geometry is formed by combining a capsule and a sphere, but the present disclosure is not limited thereto. The candidate geometric feature is, for example, a cuboid, a cube, a capsule, or a sphere, but is not limited thereto.

The volume constraint condition is a preset condition configured for constraining a volume of the object geometry. The volume constraint condition may be selecting a smallest volume from a plurality of volumes, or may be selecting a volume less than a volume threshold.

The computer device may obtain a plurality of preset candidate geometric features, and iteratively generate, by using a plurality of candidate geometric features, a plurality of candidate geometries corresponding to the first object.

For each iteration, the computer device obtains the candidate geometric feature used in the iteration, and constructs the local geometry surrounding the at least one part of the first object based on the body shape feature of the first object and the candidate geometric feature used in the iteration, to obtain the candidate geometry formed by the local geometries in the iteration. The candidate geometry includes a plurality of local geometries, and the local geometry surrounds at least one part of the first object. According to similar processing, the computer device can obtain the candidate geometry in each iteration.

The computer device determines a volume of each candidate geometry, and obtains the preset volume constraint condition. The computer device respectively performs matching on the volume of the candidate geometry obtained in each iteration with the volume constraint condition, selects a volume satisfying the volume constraint condition from the volumes, and determines the candidate geometry corresponding to the selected volume. The candidate geometry corresponding to the selected volume is determined as the object geometry of the first object.

In this embodiment, a different candidate geometric feature is used in each iteration. For example, in the first iteration, a capsule is selected to construct a candidate geometry, and in the second iteration, a sphere is selected to construct a candidate geometry.

In this embodiment, the candidate geometric feature in each iteration is obtained. For each iteration, the candidate geometry of the first object is generated in the iteration based on the body shape feature and the candidate geometric feature of the iteration, so that the candidate geometry of the first object can be generated in different iterations by using different geometric features, to determine which geometric feature can best fit the somatotype of the first object. The volume corresponding to the candidate geometry in each iteration is determined, and a candidate geometry corresponding to a volume satisfying the volume constraint condition is selected from the volumes as the object geometry, so that a geometry that best fits the first object can be accurately selected based on the volume of the candidate geometry. In addition, the volume constraint condition may be selecting a candidate geometry having a smallest volume, where the candidate geometry having the smallest volume best fits the somatotype of the first object, to obtain a geometry that can accurately represent the somatotype of the first object.

In an embodiment, the body shape feature is represented by a plurality of key points of the first object, and the determining a volume corresponding to the candidate geometry in each iteration includes:

determining, in each iteration, a key point belonging to the first object in the candidate geometry; obtaining a preset key point constraint condition, and based on a key point belonging to the first object in each candidate geometry, selecting, from the candidate geometry obtained in each iteration, the candidate geometry having the key point satisfying the key point constraint condition; determining each candidate geometry satisfying the key point constraint condition; and determining a volume corresponding to each selected candidate geometry.

The key point constraint condition is a condition for selecting the candidate geometry by using the key point. The body shape feature of the first object may be represented by using a plurality of key points. The key point constraint condition may be that the candidate geometry includes a preset quantity of key points, or that the candidate geometry includes all key points.

The computer device obtains a plurality of key points of the first object, to represent a body shape feature of the first object by using the plurality of key points. In each iteration, the computer device determines key points that are in the candidate geometry and that belong to the first object, that is, determines which key points of the first object are included in the candidate geometry. The computer device obtains a key point constraint condition, and based on the key point belonging to the first object in each candidate geometry, selects, from the candidate geometry obtained in each iteration, the candidate geometry having the key point satisfying the key point constraint condition.

The computer device determines the volume corresponding to each selected candidate geometry, and obtains the volume constraint condition. The computer device performs matching on the selected volumes with the volume constraint condition, selects a volume satisfying the volume constraint condition from the volumes, and determines the candidate geometry corresponding to the selected volume as the object geometry of the first object.

For example, the computer device selects a candidate geometry including all key points from the candidate geometries obtained in each iteration, determines a volume of the selected candidate geometry, and uses a candidate geometry having a smallest volume as the object geometry of the first object, so that the obtained object geometry includes all key points of the first object and has a smallest volume, enabling the object geometry to best fit the somatotype of the first object.

In this embodiment, the key point may be the skinning key point, and the key point constraint condition may be that the candidate geometry includes a preset quantity of skinning key points of the first object, or includes all skinning key points of the first object.

In this embodiment, in each iteration, the key point belonging to the first object in the candidate geometry is determined, the preset key point constraint condition is obtained, and the candidate geometry having the key point satisfying the key point constraint condition is selected from the candidate geometry obtained in each iteration based on the key point belonging to the first object in each candidate geometry, so that the candidate geometry that conforms to a key point constraint can be preliminarily selected. Next, the volume corresponding to each candidate geometry satisfying the key point constraint condition is determined, thereby further selecting, from the volumes, the candidate geometry corresponding to the volume satisfying the volume constraint condition. In this way, the selected candidate geometry best fits the somatotype of the first object, so that model interpenetration caused by a difference between somatotypes of the character before and after migration is effectively avoided.

In an embodiment, as shown in FIG. 6, the migrating the object trajectory information of the second object to the object geometry, to obtain object trajectory information of the object geometry includes the following operations.

Operation S602: Obtain a first bone hierarchical relationship of the first object, the first bone hierarchical relationship representing a hierarchical relationship among first bones of the first object.

Operation S604: Obtain a second bone hierarchical relationship of the second object, the second bone hierarchical relationship representing a hierarchical relationship among second bones of the second object.

The first bone hierarchical relationship represents the hierarchical relationship between the first bones of the first object, and the second bone hierarchical relationship represents the hierarchical relationship between the second bones of the second object.

The first object includes a plurality of parts, and the parts include respective first bones. The second object includes a plurality of parts, and the parts include respective second bones.

The computer device obtains the hierarchical relationship between the first bones of the first object, namely, the first hierarchical relationship, and the computer device obtains the hierarchical relationship between the second bones of the second object, namely, the second hierarchical relationship.

Operation S606: Perform hierarchical matching on the first bone hierarchical relationship and the second bone hierarchical relationship to obtain a one-to-one matching relationship between the first bones and the second bones.

The computer device performs hierarchical matching on the first bones and the second bones based on the first bone hierarchical relationship and the second bone hierarchical relationship, to construct a one-to-one matching relationship between the first bones and the second bones.

In this embodiment, the one-to-one matching relationship between the first bones and the second bones is used as a one-to-one matching relationship between parts to which the first bones belong and parts to which the second bones belong.

Operation S608: Migrate the object trajectory information of the second object to the object geometry based on the matching relationship, to obtain the object trajectory information of the object geometry.

The computer device migrates the object trajectory information of the second object to the object geometry based on the matching relationship, to obtain the object trajectory information of the object geometry.

In this embodiment, the object trajectory information of the second object includes trajectory information of each of the parts of the second object. The computer device respectively migrates the trajectory information of each of the parts of the second object to a corresponding part in the object geometry based on the one-to-one matching relationship between the first bones and the second bones, to obtain the initial trajectory information of each of the parts of the first object. The initial trajectory information of each of the parts of the first object is trajectory information of each of the parts of the object geometry, so that the object trajectory information of the object geometry is obtained.

In this embodiment, based on the matching relationship, in a preset pose of the first object and a preset pose of the second object, the object trajectory information of the second object is migrated to the first object in a static pose, so that the first object and the second object migrate the object trajectory information in a same posture. The preset pose may be a static pose of the object.

In this embodiment, the first bone hierarchical relationship represents the hierarchical relationship between the first bones of the first object, the second bone hierarchical relationship represents the hierarchical relationship between the second bones of the second object. The hierarchical matching is performed on the first bone hierarchical relationship of the first object and the second bone hierarchical relationship of the second object, to obtain the one-to-one matching relationship between the first bones and the second bones. In this way, each bone of the second object can be mapped to a bone of the first object, so that based on a matching relationship between bones, the object trajectory information of the second object is migrated to the object geometry, to obtain the object trajectory information of the object geometry.

In an embodiment, the performing hierarchical matching on the first bone hierarchical relationship and the second bone hierarchical relationship to obtain a one-to-one matching relationship between the first bones and the second bones includes:
obtaining a standard bone hierarchical relationship of a standard skeleton, the standard bone hierarchical relationship representing a hierarchical relationship among standard bones of the standard skeleton; performing hierarchical mapping on the first bone hierarchical relationship and the standard bone hierarchical relationship, to obtain a one-to-one mapping relationship between the first bones and the standard bones; performing hierarchical mapping on the second bone hierarchical relationship and the standard bone hierarchical relationship, to obtain a one-to-one mapping relationship between the second bones and the standard bones; and constructing, for each standard bone, a matching relationship between the first bone and the second bone that have the mapping relationship with the standard bone.

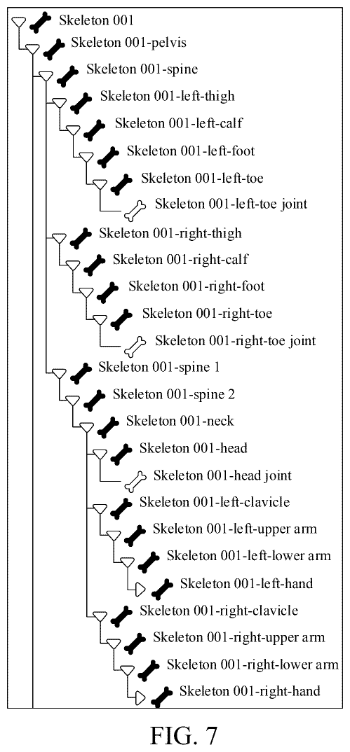

The standard skeleton is a skeleton generated by using a plurality of standard bones. Each standard bone belongs to a corresponding part. The standard bone hierarchical relationship represents a hierarchical relationship among standard bones of a standard skeleton, as shown in FIG. 7.

The computer device obtains the standard skeleton and the hierarchical relationship between the standard bones of the standard skeleton. The computer device performs hierarchical mapping on the first bone hierarchical relationship and the standard bone hierarchical relationship to respectively map each first bone of the first object to one standard bone of the standard skeleton, to obtain a one-to-one mapping relationship between the first bones and the standard bones. The mapping relationship between a first bone and a standard bone can be referred to as a first mapping relationship.

The computer device performs hierarchical mapping on the second bone hierarchical relationship and the standard bone hierarchical relationship to respectively map each second bone of the second object to one standard bone of the standard skeleton, to obtain a one-to-one mapping relationship between the second bones and the standard bones. The mapping relationship between a second bone and a standard bone can be referred to as a second mapping relationship.

The computer device performs matching on the first bones with the second bones based on the first mapping relationship and the second mapping relationship, to match the first bone with the second bone that correspond to the same standard bone, to obtain a matching relationship between the first bones and the second bones. Further, one standard bone has the mapping relationship with one first bone, and one standard bone has the mapping relationship with one second bone. Therefore, for each standard bone, the computer device constructs a matching relationship between the first bone and the second bone that have the mapping relationship with the standard bone, to obtain a one-to-one matching relationship between the first bones and the second bones.

In this embodiment, the standard skeleton is formed by bones of the parts of the object, and the standard bone hierarchical relationship represents a hierarchical relationship between the standard bones of the standard skeleton. The standard skeleton and the standard bone hierarchical relationship are both preconfigured. The hierarchical mapping is performed on the first bone hierarchical relationship and the standard bone hierarchical relationship, to obtain the one-to-one mapping relationship between the first bones and the standard bones. The hierarchical mapping is performed on the second bone hierarchical relationship and the standard bone hierarchical relationship, to obtain the one-to-one mapping relationship between the second bones and the standard bones. In this way, the first bones of the first object and the second bones of the second object can be respectively mapped to the standard bones, so that the bones of the first object and the second object can be matched by using the standard bones, and bone matching between the first object and the second object is more accurate. This is beneficial to improving accuracy of subsequent trajectory information migration.

In an embodiment, the performing position adjustment on the plurality of collision occurrence positions, to obtain the respective collision avoidance positions of the plurality of collision points includes:

performing collision detection based on the collision occurrence positions of the plurality of collision points, to obtain collision depths and collision normal vectors between the plurality of collision points; and performing position adjustment based on the collision occurrence positions, the collision depths, and the collision normal vectors, to obtain the respective collision avoidance positions of the plurality of collision points.

The collision depth is a depth between a plurality of collision points when collision occurs, and the collision depth may be represented by a distance between the collision points. The collision normal vector is a normal vector corresponding to a plurality of collision points when collision occurs.

The computer device determines a plurality of local geometries that collide when the parts of the object geometry interact, and determines a plurality of collision points at which the plurality of local geometries collide. The computer device obtains respective collision occurrence positions of the plurality of collision points, and performs collision detection on the collision occurrence positions of the plurality of collision points, to determine the collision depth between the plurality of collision points and the collision normal vector between the plurality of collision points.

For each collision occurrence position, the computer device performs position adjustment on the collision point located at the collision occurrence position based on the collision occurrence position, the collision depth, and the collision normal vector, to obtain a collision avoidance position corresponding to the collision point of the collision occurrence position. According to similar processing, a collision avoidance position corresponding to each collision point can be obtained.

In this embodiment, the computer device may obtain a preset position mapping function. The position mapping function represents a mapping relationship between collision occurrence positions and collision avoidance positions of a collision point. For each collision occurrence position, the computer device performs position adjustment on the collision point located at the collision occurrence position based on the position mapping function, the collision occurrence position, the collision depth, and the collision normal vector, to obtain the collision avoidance position of the collision point.

Further, for each collision occurrence position, the computer device substitutes the collision occurrence position, the collision depth, and the collision normal vector into the position mapping function, to obtain the collision avoidance position of the collision point.

In this embodiment, collision detection is performed based on the respective collision occurrence positions of the plurality of collision points, and the collision depth and the collision normal vector between the plurality of collision points can be accurately calculated, so that a collision degree between the collision points can be accurately reflected by using the collision depths. The position adjustment is performed based on the collision occurrence position, the collision depth, and the collision normal vector, to adjust the collision point to a position at which collision does not occur, so that the collision avoidance positions of the plurality of collision points can be obtained, thereby effectively avoiding collision caused during the interaction between the parts of the first object when the collision point is at the collision avoidance position.

In an embodiment, the performing position adjustment based on the collision occurrence positions, the collision depths, and the collision normal vectors, to obtain the respective collision avoidance positions of the plurality of collision points includes:
obtaining respective weight parameters of the plurality of local geometries; and
for each collision point, performing position adjustment based on the collision occurrence position of the collision point, the weight parameter corresponding to the local geometry to which the collision point belongs, the collision depth, and the collision normal vector, to obtain the collision avoidance position of the collision point.

The weight parameter represents respective importance degrees of the plurality of local geometries that collide during the position adjustment. A larger weight parameter corresponding to a local geometry indicates that the local geometry is more inclined to be moved to avoid collision, that is, the position adjustment of the local geometry is clearer.

For example, a weight parameter of a local geometry A is 0.7, and a weight parameter of a local geometry B is 0.3. In this case, the local geometry A is more inclined to be moved during the position adjustment, to avoid collision between the local geometry A and the local geometry B. That is, a change of a position of the local geometry A is clearer.

The weight parameter may depend on types of the plurality of local geometries that collide. When the plurality of local geometries belong to a same type, the weight parameters of the local geometries may be the same, and when the plurality of local geometries belong to different types, the weight parameters of the local geometries may be different.

For example, when all of the plurality of local geometries are upper limb parts or lower limb parts, the weight parameters of the local geometries may be the same, for example, are both 0.5. When one of the plurality of local geometries is an upper limb part, and another local geometry is a lower limb part, the weight parameter of the local geometry of the upper limb part may be 1 or 0.8, and the weight parameter of the local geometry of the lower limb part may be 0 or 0.1.

The computer device obtains the weight parameters of the plurality of local geometries, and for each collision point, performs the position adjustment based on the collision occurrence position of the collision point, the weight parameter corresponding to the local geometry to which the collision point belongs, the collision depth, and the collision normal vector, to obtain the collision avoidance position of the collision point. According to similar processing, a collision avoidance position of each collision point can be obtained.

In this embodiment, for each collision point, the position adjustment is performed based on the position mapping function, the collision occurrence position of the collision point, the weight parameter corresponding to the local geometry to which the collision point belongs, the collision depth, and the collision normal vector, to obtain the collision avoidance position of the collision point.

Further, the computer device calculates a product of the weight parameter corresponding to the local geometry to which the collision point belongs, the collision depth, and the collision normal vector, and uses a sum of the collision occurrence position of the collision point and the product as the collision avoidance position of the collision point; or uses a difference between the collision occurrence position of the collision point and the product as the collision avoidance position of the collision point.

In this embodiment, for any two of the plurality of collision points, when a collision avoidance position of one collision point is a sum of a collision occurrence position of the collision point and the product, a collision avoidance position of the other collision point is a difference between the collision occurrence position of the collision point and the product.

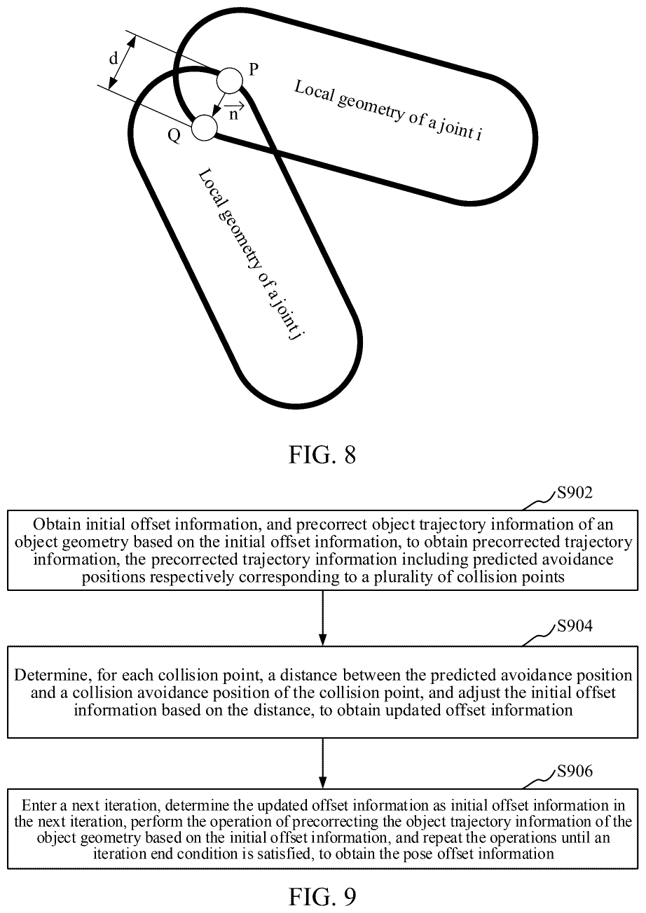

For example, as shown in FIG. 8, a part i and a part j of the first object collide during interaction. Both the part i and the part j have a plurality of collision points. A collision point on the part i is P, and a collision point on the part j is Q. Respective collision avoidance positions of the collision points P and Q can be calculated by using the following formula:

$${P}^{′} = P + {α}_{i} \cdot d \cdot \vec{n}$$

$${Q}^{′} = Q - {α}_{j} \cdot d \cdot \vec{n}$$

The collision depth is d, and the collision normal vector is \vec{n}. α represents an adjustment weight of a joint, namely, a weight parameter of a local geometry. A higher weight represents that the local geometry is more inclined to be moved to avoid collision. An upper limb joint weight is 1 by default, otherwise a weight is 0. When both joints are upper limb joints, αᵢ=αᵢ=0.5. Distribution of the weight parameters may be adjusted based on an actual requirement.

In this embodiment, the respective weight parameters of the plurality of local geometries are obtained, and a local geometry more inclined to be moved is reflected by using the weight parameter, so that for each collision point, the position adjustment is performed based on the collision occurrence position of the collision point, the weight parameter of the local geometry to which the collision point belongs, the collision depth, and the collision normal vector, to adjust the collision point to a position at which collision does not occur, thereby obtaining the respective collision avoidance positions of the plurality of collision points, and enabling the collision point to be located at the collision avoidance position, to effectively avoid collision caused by interaction of the parts of the first object. In addition, the weight parameter can reflect a position of a local geometry that is more adjusted and a position of a local geometry that is less adjusted, so that the local geometries can be adjusted in a most proper manner.

In an embodiment, the correcting the object trajectory information of the object geometry based on the collision occurrence positions and the collision avoidance positions, to obtain object trajectory information of the first object includes:
performing pose offset prediction based on the collision occurrence positions and the collision avoidance positions, to obtain pose offset information between the plurality of local geometries; and correcting the object trajectory information of the object geometry based on the pose offset information, to obtain the object trajectory information of the first object.

The pose offset information is a set of joint rotation offset information of the parts surrounded by the plurality of local geometries. The joint rotation offset information represents a difference between two joint rotation amounts of the collision point. One joint rotation amount is a joint rotation amount of the collision point at a collision occurrence position, and the other joint rotation amount is a joint rotation amount of the collision point at a collision avoidance position.

When the collision points are located at the collision occurrence positions, the local geometries to which the collision points belong collide; and when the collision points are located at the collision avoidance positions, and the local geometries to which the collision points do not collide. In this case, the pose offset information is offset information from that the collision occurs to that the collision does not occur, and the plurality of local geometries can be prevented, by using the pose offset information, from colliding during the interaction.

The computer device performs pose offset prediction based on the collision occurrence positions and the collision avoidance positions, to determine difference information of each collision point from the collision occurrence position to the collision avoidance position. In this way, the pose offset information between the plurality of local geometries can be obtained, so that the plurality of local geometries do not collide during the interaction.

The computer device corrects the object trajectory information of the object geometry based on the pose offset information, to obtain the corrected object trajectory information, and uses the corrected object trajectory information as the object trajectory information of the first object.

In this embodiment, the pose offset information between the plurality of local geometries includes the offset information of each local geometry. For each collision point, the computer device performs, based on the collision occurrence position and the collision avoidance position of the collision point, pose offset prediction on a local geometry to which the collision point belongs, to obtain offset information corresponding to the local geometry. The offset information corresponding to each local geometry is integrated to obtain the pose offset information.

In this embodiment, the object trajectory information of the second object includes joint rotation information of each of the parts of the second object, and the pose offset information includes joint rotation offset information of each of the parts surrounded by the plurality of local geometries. The pose offset prediction is performed based on the collision occurrence positions and the collision avoidance positions, to obtain the joint rotation offset information of each of the parts surrounded by the plurality of local geometries, namely, the joint rotation offset information when the collision does not occur. Based on the joint rotation offset information of each of the parts surrounded by the plurality of local geometries, the joint rotation information of a corresponding part of the object geometry is corrected, to obtain the corrected joint rotation information, so that the object trajectory information of the first object can be obtained.

In this embodiment, the pose offset prediction is performed based on the collision occurrence positions and the collision avoidance positions, to calculate a difference between the joint rotation amount of each collision point at the collision occurrence position and the joint rotation amount of each collision point at the collision avoidance position, thereby accurately obtaining the pose offset information of the plurality of local geometries. Based on the pose offset information, the object trajectory information of the object geometry is corrected, so that the trajectory information of each of the parts that collide during the interaction can be adjusted, to obtain the trajectory information of the parts that do not collide during the interaction. In this way, trajectory information of objects of different somatotypes can be accurately migrated, and the migrated trajectory information can completely conform to the object, to improve accuracy of trajectory migration.

In an embodiment, as shown in FIG. 9, the performing pose offset prediction based on the collision occurrence positions and the collision avoidance positions, to obtain pose offset information between the plurality of local geometries includes:

Operation S902: Obtain initial offset information, and pre-correct the object trajectory information of the object geometry based on the initial offset information, to obtain pre-corrected trajectory information, the pre-corrected trajectory information including predicted avoidance positions respectively corresponding to the plurality of collision points.

The initial offset information represents an initial difference between the two joint rotation amounts of the collision point. One joint rotation amount is the joint rotation amount of the collision point at the collision occurrence position, and the other joint rotation amount is the joint rotation amount of the collision point at the collision avoidance position.

The pre-corrected trajectory information is trajectory information that is obtained by correcting the object trajectory information of the object geometry by using the initial offset information, and that predicts the local geometries do not collide during the interaction. The pre-corrected trajectory information includes respective predicted avoidance positions of the plurality of collision points. The predicted avoidance position is a position predicting that the collision can be avoided, that is, a position predicting that the collision can be evaded.

The computer device obtains preset initial offset information, and pre-corrects the object trajectory information of the object geometry based on the initial offset information, to obtain pre-corrected trajectory information of the object geometry. The pre-corrected trajectory information includes predicted avoidance positions respectively corresponding to the plurality of collision points.

Operation S904: Determine, for each collision point, a distance between the predicted avoidance position and the collision avoidance position of the collision point, and adjust the initial offset information based on the distance, to obtain updated offset information.

The computer device calculates the distance between the predicted avoidance position and the corresponding collision avoidance position of each collision point, and adjusts the initial offset information based on the distance, to obtain the updated offset information.

Further, the predicted avoidance position and the collision avoidance position of the same collision point are corresponding.

For each collision point, the predicted avoidance position of the collision point is determined, and the collision avoidance position of the collision point is determined, thereby determining the distance between the predicted avoidance position and the collision avoidance position of the collision point.

Operation S906: Enter a next iteration, and determine the updated offset information as initial offset information in the next iteration, perform the operation of pre-correcting the object trajectory information of the object geometry based on the initial offset information, and repeat the operations until an iteration end condition is satisfied, to obtain the pose offset information.

After the updated offset information is obtained, the next iteration is entered, the updated offset information is determined as the initial offset information in the next iteration, the operation of pre-correcting the object trajectory information of the object geometry based on the initial offset information continues to be performed, and the operations are repeated until the iteration end condition is satisfied, to obtain the pose offset information.

In this embodiment, the iteration end condition may be that a preset quantity of iterations is reached, or a distance between a predicted avoidance position and a collision avoidance position of a same collision point in an iteration is less than or equal to a distance threshold. For example, if the quantity of iterations is 20, updated offset information obtained in the 20^{th} iteration is used as the pose offset information.

Alternatively, when the distance between the predicted avoidance position obtained in the iteration and the corresponding collision avoidance position is less than or equal to the distance threshold, the initial offset information in the iteration is used as the pose offset information.

In this embodiment, the initial offset information includes a predicted rotation amount of each of the parts during the interaction; the object trajectory information of the object geometry includes respective joint rotation amounts of the parts; and the pose offset information includes respective joint rotation offset amounts of the parts when the parts do not collide during the interaction.

The computer device obtains the respective predicted joint rotation amounts of the parts, and pre-corrects a joint rotation amount of a corresponding part of the object geometry based on the respective predicted joint rotation amounts of the parts, to obtain a pre-corrected joint rotation amount of the corresponding part of the object geometry. The computer device performs position adjustment on a collision occurrence position of the corresponding part by using the respective pre-corrected joint rotation amounts of the parts of the object geometry, to obtain the predicted avoidance positions respectively corresponding to the plurality of collision points. The distances between the predicted avoidance positions and the corresponding collision avoidance positions are determined, and respective predicted joint rotation amounts of the parts in a current iteration are adjusted based on the distances, to obtain updated predicted joint rotation amounts. A next iteration is entered, the updated predicted joint rotation amounts are determined as predicted joint rotation amounts in a next iteration, the operation of pre-correcting a joint rotation amount of a corresponding part of the object geometry based on the respective predicted joint rotation amounts of the parts continues to be performed, and the operations are repeated until the iteration end condition is satisfied, to obtain the respective joint rotation offset amounts of the parts. Based on the respective joint rotation offset amounts of the parts, the joint rotation amount of the corresponding part is corrected, to obtain the object trajectory information of the first object.

In this embodiment, the computer device may construct a Jacobian matrix based on the predicted avoidance positions and the collision avoidance positions of the collision points, and the distances between the predicted avoidance positions and the collision avoidance positions. The updated predicted joint rotation amount is calculated based on the Jacobian matrix, the distance between the predicted avoidance position and the corresponding collision avoidance position, and the predicted joint rotation amount.

In this embodiment, the initial offset information is obtained, and the object trajectory information of the object geometry is pre-corrected based on the initial offset information, to predict the respective predicted avoidance positions of the plurality of collision points. A distance difference between a predicted avoidance position and a collision avoidance position of each collision point is determined, so that a difference between the avoidance position obtained through correction and the collision avoidance position can be reflected based on a distance between the avoidance position obtained through prediction based on the initial offset information and the real collision avoidance position. In this way, the initial offset information is adjusted based on the distance difference, so that an avoidance position obtained by using updated offset information obtained in each iterative adjustment is closer to the real collision avoidance position. A next iteration is entered, and the updated offset information is determined as initial offset information in the next iteration. The operation of pre-correcting the object trajectory information of the object geometry based on the initial offset information continues to be performed. The operations are repeated until the iteration end condition is satisfied, to obtain the pose offset information. Therefore, the predicted avoidance position can continuously approach the real collision avoidance position in a plurality of iterations, so that migration of the trajectory information is more accurate.

In an embodiment, the object trajectory information of the object geometry includes limb trajectory information of each of at least two first limbs of the first object, and joint rotation information of each of at least two parts of the first object. The object trajectory information of the second object includes limb trajectory information of each of at least two second limbs of the second object and joint rotation information of each of at least two parts of the second object, and the at least two first limbs of the first object and the at least two second limbs of the second object are in a one-to-one correspondence. The method further includes:
determining first interaction information between the at least two first limbs based on the limb trajectory information of each of the at least two first limbs of the first object;
determining second interaction information between the at least two second limbs based on the limb trajectory information of each of the at least two second limbs of the second object; and
determining limb interaction constraint information between the first object and the second object based on the first interaction information and the second interaction information.

The correcting the object trajectory information of the object geometry based on the collision occurrence positions and the collision avoidance positions, to obtain object trajectory information of the first object includes:
correcting the limb trajectory information of the plurality of first limbs based on the limb interaction constraint information, and correcting the joint rotation information of the at least two parts of the first object based on the collision occurrence positions and the collision avoidance positions, to obtain the object trajectory information of the first object.

The limb trajectory information of the first limb is trajectory information corresponding to the first limb, and may be specifically trajectory information formed by positions of the first limb at different moments.

The limb trajectory information of the second limb is trajectory information corresponding to the second limb, and may be specifically trajectory information formed by positions of the second limb at different moments.

Each part of the first object includes a joint, and each first limb includes a joint. Each part of the second object includes a joint, and each second limb includes a joint. Each joint includes joint rotation information, which represents a rotation amount of the joint. Further, the joint rotation information includes rotation components of the joint in various directions, for example, respective rotation components on x, y, and z axes.

The object trajectory information of the object geometry includes limb trajectory information of each of the plurality of first limbs of the first object and joint rotation information of each of the plurality of first limbs.

The object trajectory information of the second object includes limb trajectory information of each of the plurality of second limbs of the second object and joint rotation information of each of the plurality of second limbs.

The first interaction information is information representing an interaction relationship between a plurality of first limbs. The interaction relationship between the plurality of first limbs is referred to as the first interaction relationship.

The second interaction information is information representing an interaction relationship between a plurality of second limbs. The interaction relationship between the plurality of second limbs is referred to as the second interaction relationship.

The limb interaction constraint information is a constraint on an interaction relationship between a plurality of limbs that interact with each other in a trajectory migration process. The limb interaction constraint information is a constraint on the interaction relationship between the plurality of first limbs and the interaction relationship between the plurality of second limbs in a process in which the limb trajectory information of the plurality of first limbs is migrated to the plurality of second limbs.

The interaction relationship between the plurality of first limbs is referred to as the first interaction relationship. The interaction relationship between the plurality of second limbs is referred to as the second interaction relationship. The limb interaction constraint information between the first object and the second object is a constraint between the first interaction relationship and the second interaction relationship.

The limb interaction constraint information may be joint chain constraint information.

The computer device obtains the limb trajectory information of each of the at least two first limbs of the first object, and determines first interaction information between the at least two first limbs based on the limb trajectory information of each of the at least two first limbs. The computer device obtains the limb trajectory information of each of the at least two second limbs of the second object, and determines second interaction information between the at least two second limbs based on the limb trajectory information of each of the at least two second limbs. The computer device determines the limb interaction constraint information between the first object and the second object based on the first interaction information and the second interaction information.

The computer device corrects, based on the limb interaction constraint information, the limb trajectory information of each of the plurality of first limbs, to obtain corrected limb trajectory information of each of the plurality of first limbs; and corrects the joint rotation information of each of the plurality of first limbs based on the collision occurrence positions and the collision avoidance positions, to obtain the corrected joint rotation information of each of the plurality of first limbs. The corrected limb trajectory information and the corrected joint rotation information of each of the plurality of first limbs can form the object trajectory information of the first object.

In this embodiment, the first interaction information between the at least two first limbs is determined, the second interaction information between the second limbs is determined, and the limb interaction constraint information between the first object and the second object is generated based on the first interaction information and the second interaction information. The generated limb interaction constraint information enables the plurality of first limbs to obtain the interaction relationship between the plurality of second limbs. The limb trajectory information of the plurality of first limbs is corrected based on the limb interaction constraint information, so that the migrated limb trajectory information retains the interaction relationship between the plurality of second limbs, and conforms to features of the limbs of the first object. The joint rotation information of the plurality of first limbs is corrected based on the collision occurrence positions and the collision avoidance positions, so that the joint rotation information in the object trajectory information migrated to the first object better fits the somatotype of the first object, to avoid model interpenetration generated after migration due to a large difference between the somatotypes of the second object and the first object.

In an embodiment, the determining second interaction information between the at least two second limbs based on the limb trajectory information of each of the at least two second limbs of the second object includes:

pre-correcting the limb trajectory information of each of the at least two second limbs of the second object, to obtain pre-corrected limb trajectory information of each of the at least two second limbs; and determining the second interaction information between the at least two second limbs based on the pre-corrected limb trajectory information of each of the at least two second limbs.

The pre-corrected limb trajectory information is limb trajectory information obtained after the limb trajectory information of the second limb is pre-corrected. The pre-correction is correction processing for pre-estimating the initial trajectory information of the second limb.

For each second limb of the at least two second limbs, the computer device pre-corrects the limb trajectory information of the second limb, to obtain the pre-corrected limb trajectory information of the second limb, thereby obtaining the pre-corrected limb trajectory information of each second limb. The pre-corrected limb trajectory information is trajectory information of the second limb after the pre-correction, and may be specifically trajectory information formed by positions of the second limb at different moments.

The computer device selects, based on the pre-corrected limb trajectory information of each of the at least two second limbs, trajectory information indicating that the at least two second limbs interact, and uses the trajectory information indicating that the at least two second limbs interact as the second interaction information between the at least two second limbs.

In this embodiment, the limb trajectory information of each of the at least two second limbs of the second object is pre-corrected, to obtain the pre-corrected limb trajectory information of each of the at least two second limbs. The second interaction information between the at least two second limbs is determined based on the pre-corrected limb trajectory information of each of the at least two second limbs, and the interaction relationship between the second limbs after the pre-correction can be pre-estimated.

In an embodiment, the method further includes:
determining first pose information of each of the at least two first limbs based on the limb trajectory information of each of the at least two first limbs of the first object;
determining second pose information of each of the at least two second limbs based on the limb trajectory information of each of the at least two second limbs of the second object; and
generating, for each first limb, single-limb constraint information between the first limb and a corresponding second limb based on the first pose information of the first limb and the second pose information of the corresponding second limb.

The correcting the limb trajectory information of the plurality of first limbs based on the limb interaction constraint information includes:
correcting, for each first limb, the limb trajectory information of the first limb based on the limb interaction constraint information and single-limb constraint information between the first limb and a corresponding second limb.

The first pose information is information representing a pose of the first limb. The second pose information is information representing a pose of the second limb.

The single-limb constraint information is constraint information between a first limb of the first object and a corresponding second limb of the second object. The single-limb constraint information is a constraint condition for a single first limb in a trajectory migration process, and specifically, is a limitation condition for the first limb that needs to be considered when the limb trajectory information of the first limb is migrated to the corresponding second limb.

The single-limb constraint information may be single-joint-chain constraint information. The single-joint-chain constraint information is constraint information between a second limb of the second object and a corresponding first limb. The single-joint-chain constraint information is a constraint condition for a single second limb in a trajectory migration process, and specifically, is a limitation condition for the second limb that needs to be considered when the limb trajectory information of the second limb is migrated to the corresponding first limb.

The computer device obtains limb trajectory information of each of the at least two first limbs of the first object, and for each first limb, the computer device determines the limb pose information of the first limb based on the limb trajectory information of the first limb. The computer device obtains the limb trajectory information of each of the at least two second limbs of the second object, and for each second limb, the computer device determines the second pose information of the second limb based on the limb trajectory information of the second limb. For each first limb, the computer device determines a difference between the first pose information of the first limb and the second pose information of the corresponding second limb, and uses the difference as single-limb constraint information between the first limb and the corresponding second limb.

In this embodiment, the first pose information of each of the plurality of first limbs of the first object and the second pose information of each of the plurality of second limbs of the second object are obtained. For each first limb, the single-limb constraint information between the first limb and the corresponding second limb is generated based on the first pose information of the first limb and the second pose information of the corresponding second limb. The generated single-limb constraint information enables the first limb to obtain the pose information of the second limb. For each first limb, the limb trajectory information of the first limb is corrected based on the joint-chain interaction constraint information and the single-limb constraint information between the first limb and the second limb, so that the first limbs of the first object can obtain a pose consistent with a pose of the corresponding second limbs of the second object, and interaction between the limbs of the second object also remains consistent with interaction between the limbs of the first object. In this way, migration of the trajectory information is more accurate.

In an embodiment, the first limb includes a first joint chain, the first joint chain is formed by connecting a plurality of joints and parts between the plurality of joints of the first object, the second limb includes a second joint chain, the second joint chain is formed by connecting a plurality of joints and parts between the plurality of joints of the second object, the single-limb constraint information is constraint information between the first joint chain and the second joint chain, the limb interaction constraint information is constraint information between the first interaction relationship and the second interaction relationship, the first interaction relationship is the interaction relationship between the at least two first joint chains, and the second interaction relationship is the interaction relationship between the at least two second joint chains.

The first object includes a plurality of first limbs. A first limb includes a plurality of joints and at least one part connecting the plurality of joints. The plurality of joints of the first limb and the part between the plurality of joints are connected to form the first joint chain.

The second object includes a plurality of second limbs. A second limb includes a plurality of joints and at least one part connecting the plurality of joints. The plurality of joints of the second limb and the part between the plurality of joints are connected to form the second joint chain. The plurality of first joint chains of the first object and the plurality of second joint chains of the second object are in a one-to-one correspondence.

The single-limb constraint information is single-joint-chain constraint information. The single-joint-chain constraint information is constraint information on a pose of a single-joint-chain. The object geometry surrounds the first object. In a process of migrating the object trajectory information of the second object to the object geometry, the pose of the first joint chain is migrated to the second joint chain, so that the second joint chain has the pose of the first joint chain. The single-joint-chain constraint information is configured for constraining a migrated pose, so that the pose migrated to the second joint chain can fit the second joint chain.

The limb interaction constraint information is joint-chain interaction constraint information. The joint-chain interaction constraint information is constraint information on an interaction relationship between joint chains. In a process of migrating the object trajectory information of the second object to the object geometry, a first interaction relationship between two first joint chains is migrated to two second joint chains, to obtain a second interaction relationship between the two second joint chains. The multi-joint-chain interaction constraint information is configured for constraining a migrated interaction relationship, so that during migration, cooperation between two joint chains is considered, and therefore, migration of a limb trajectory is more accurate.

In an embodiment, a trajectory information processing method is provided, applied to a computer device. The method includes the following operations.

A body shape feature of a first object is obtained, the body shape feature being represented by using a plurality of key points of the first object.

A candidate geometric feature in each iteration is obtained, and for each iteration, a candidate geometry of the first object is generated in the iteration based on the body shape feature and the candidate geometric feature of the iteration, the object geometry including a plurality of local geometries, and the local geometry surrounding at least one part of the first object.

In each iteration, a key point belonging to the first object in the candidate geometry is determined.

A preset key point constraint condition is obtained, and based on a key point belonging to the first object in each candidate geometry, the candidate geometry having the key point satisfying the key point constraint condition is selected from the candidate geometry obtained in each iteration.

A volume corresponding to each selected candidate geometry is determined, a volume satisfying the volume constraint condition is selected from the volumes, and the candidate geometry corresponding to the selected volume is determined as the object geometry.

A first bone hierarchical relationship of the first object is obtained. The first bone hierarchical relationship represents a hierarchical relationship among first bones of the first object.

A second bone hierarchical relationship of the second object is obtained. The second bone hierarchical relationship represents a hierarchical relationship among second bones of the second object.

A standard bone hierarchical relationship of a standard skeleton is obtained. The standard bone hierarchical relationship represents a hierarchical relationship among standard bones of the standard skeleton.

Hierarchical mapping is performed on the first bone hierarchical relationship and the standard bone hierarchical relationship, to obtain a one-to-one mapping relationship between the first bones and the standard bones.

Hierarchical mapping is performed on the second bone hierarchical relationship and the standard bone hierarchical relationship, to obtain a one-to-one mapping relationship between the second bones and the standard bones.

For each standard bone, a matching relationship is constructed between the first bone and the second bone that have the mapping relationship with the standard bone.

The object trajectory information of the second object is migrated to the object geometry based on the matching relationship, to obtain the object trajectory information of the object geometry.

The object trajectory information of the second object includes limb trajectory information of each of at least two second limbs of the second object, and joint rotation information of each of at least two parts of the second object.

The object trajectory information of the object geometry includes limb trajectory information of each of at least two first limbs of the first object, and joint rotation information of each of at least two parts of the first object. The at least two first limbs of the first object and the at least two second limbs of the second object are in a one-to-one correspondence.

First pose information of each of the at least two first limbs and second pose information of each of the at least two second limbs are obtained.

For each first limb, single-joint-chain constraint information between the first limb and a corresponding second limb is generated based on the first pose information of the first limb and the second pose information of the corresponding second limb.

First interaction information between the at least two first limbs and second interaction information between the at least two second limbs are determined, and joint-chain interaction constraint information between the first object and the second object is generated based on the first interaction information and the second interaction information.

For each first limb, based on the joint-chain interaction constraint information and the single-joint-chain constraint information between the first limb and the corresponding second limb, the limb trajectory information of the first limb is corrected, to obtain corrected limb trajectory information of each of the first limbs.

A plurality of collision points at which the local geometries collide during the interaction are determined, collision occurrence positions of the plurality of collision points are determined, and collision detection is performed based on the respective collision occurrence positions of the plurality of collision points, to obtain collision depths and collision normal vectors between the plurality of collision points.

Weight parameters of the plurality of local geometries are obtained, and for each collision point, position adjustment is performed based on the collision occurrence position of the collision point, the weight parameter of the local geometry to which the collision point belongs, the collision depth, and the collision normal vector, to obtain the collision avoidance position of the collision point. The collision avoidance positions are configured for avoiding collision of the plurality of local geometries during the interaction.

Respective predicted joint rotation amounts of the parts of the object geometry during the interaction are obtained, and a joint rotation amount of each part of the object geometry is pre-corrected based on the predicted joint rotation amounts of the parts, to obtain a pre-corrected joint rotation amount of each part of the object geometry. The computer device performs position adjustment on the collision occurrence position of each part based on a pre-corrected joint rotation amount of each part of the object geometry, to obtain respective predicted avoidance positions of the plurality of collision points.

For each collision point, a distance between a predicted avoidance position and the collision avoidance position of the collision point is determined, the predicted joint rotation amounts of the parts in a current iteration is adjusted based on the distance, to obtain the updated predicted rotation joint amount. A next iteration is entered, the updated predicted joint rotation amounts are determined as predicted joint rotation amounts in a next iteration, the operation of pre-correcting a joint rotation amount of a corresponding part of the object geometry based on the respective predicted joint rotation amounts of the parts continues to be performed, and the operations are repeated until the iteration end condition is satisfied, to obtain the joint rotation offset amounts of the parts.

For each part, the joint rotation amount of the part in the object geometry is corrected based on the joint rotation offset of the part, to obtain corrected joint rotation information of each of the joints. The object trajectory information of the first object is formed by using the corrected joint rotation information of each of the joints and the corrected limb trajectory information of each of the first limbs.

In an embodiment, an application scenario of a trajectory information processing method is provided, that is, the method is applied to a real-time animation retargeting scenario. Animation retargeting is intended to migrate an existing animation resource to a new object. Based on this technology, when a new animation object is produced, an animation does not need to be additionally produced for the new animation object, but the existing animation can be reused at zero costs. The animation retargeting is necessary in a mainstream animation production process. The trajectory information processing method in this embodiment may replace a step trajectory optimization technology of the animation retargeting, and is directly combined with an existing animation production process. In terms of specific application, the trajectory information processing method in this embodiment may be applied to any scenario in which an animation needs to be reused, for example, a three-dimensional game, a meta-universe product, virtual live streaming, or movie and television media, but is not limited thereto. A footstep trajectory of an animation sequence may be migrated between any object without an animationizer producing a corresponding animation for each object, thereby implementing zero-cost reuse of animation materials.

Real-time animation stream: is a real-time animation collection manner, generating animation data at each moment in real time, for example, an inertial motion capture, an optical motion capture, or a visual motion capture solution, or a real-time person action in a game. Different from processing offline animation data, processing of the real-time animation stream requires a streaming animation processing manner.

An animation sequence is logic and data configured for driving an item to move and achieve a dynamic effect, and is widely applied to fields such as games and movies, for example, object actions in a three-dimensional game. The “animation sequence” in this embodiment may be a limb animation of an object in a 3D scene.

The “limb animation” in this embodiment refers to a body animation of a person object in a 3D scene. The person limb animation is very widely used in fields such as games, live streaming, and movie and television. Each object in the 3D game is driven by a limb animation, so that the object generates a dynamic effect conforming to a plot and an object characteristic.

The animation retargeting refers to migration of an animation sequence between different objects. For example, there is an animation sequence of an object A and a model of an object B. The animation retargeting means migrating the animation sequence of the object A to the object B, and adapting to an object characteristic of the object B while retaining action characteristics such as joint bending and action trend of the object A. The object characteristic is, for example, a skeleton topology and a model shape.

The footstep trajectory, namely, limb trajectory information, is a trajectory formed by a step position of each frame of an object in a provided animation sequence. Using a human-shaped object as an example, the first limb and the second limb are lower limbs of the human-shaped object, and the step position is a position sequence of an ankle joint. The second object is a person of a to-be-migrated animation, namely, the object A in the definition of the animation retargeting. A source animation, namely, object trajectory information of the second object, refers to a to-be-migrated animation sequence, namely, the animation sequence of the object A in the definition of the animation retargeting. A first object or a first object model is an animation object that accepts migration, namely, the object B in the definition of the animation retargeting.

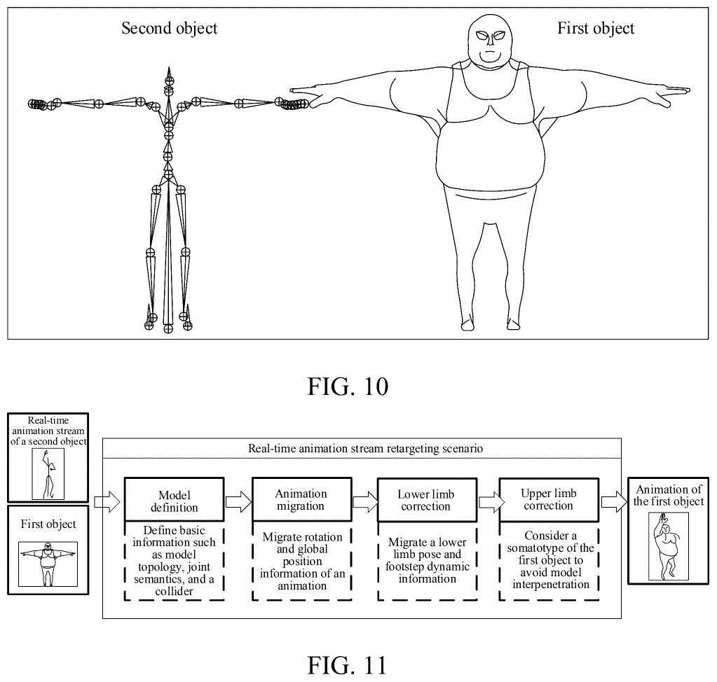

A binding pose, namely, a preset pose, is a default pose used for binding bones when a modeling engineer produces a three-dimensional model, which is generally an A-Pose or a T-Pose, as shown in FIG. 10.

The trajectory information processing method in the present disclosure may be applied to any application that needs to reuse an animation in a real-time scenario, such as a game and a digital human live streaming. Based on the trajectory information processing method, an animation resource generated in real time may be reused to the first object, to drive a target person object to perform a same movement, to obtain a real-time object dynamic effect in a game or live streaming.

In addition, real-time retargeting also covers application scenarios of all offline retargeting solutions. For example, an animation resource in a readable file form, to generate an animation file of the first object.

### Method of Use:

The trajectory information processing method in the present disclosure is provided in a form of an independent tool library, supports mainstream Windows and Linux operating systems, may be invoked by using languages such as c++ and python, or may be integrated into a game engine (for example, an Unreal Engine, UE) as a plug-in for use.

Inputs of a real-time retargeting tool include:

a real-time animation stream of the second object, to be specific, action information of the second object at a current time, is represented by using joint rotation transformation of parts of the object.

A rest pose of a second bone is a standard pose of the second bone, and is generally a T-pose or an A-pose.

A model file may be in an fbx format. The model file includes a model bone and a model mesh body.

A rest pose of a first bone is a standard pose of the first bone, and is generally a T-pose or an A-pose.

In addition, a user also needs to provide some necessary configurations, which mainly include:

A bone mapping table of the second bone is configured for matching the second bone with a built-in standard bone.

A bone mapping table of the first bone is configured for matching the first bone with the built-in standard bone.

A system outputs an animation stream based on the first object, and an output result can drive motion of the first object in real time. Alternatively, the result may be stored as an offline file as an offline animation resource.

An overall procedure of the trajectory information processing method in this embodiment is shown in FIG. 11. Main inputs are a real-time animation stream of the second object and the first object model. A “Model definition” part can determine basic information of the second object and the first object model, including a topology structure of a bone, joint semantics (indicating that which joint is the head and which joint is the hand), collider information of a model (configured for a shape of an approximate model), and the like. An “Animation migration” part migrates rotation information and global position information of a source animation, that is, the object trajectory information. A “Lower limb correction” part is configured for optimizing a footstep trajectory to match different limb ratios, such as a leg length and a crotch width, and migrating footstep dynamic information of a source animation stream, to avoid animation quality problems such as step sliding. An “Upper limb correction” part further adjusts a pose of upper limb joints, and considers a somatotype of the first object to avoid model interpenetration, so that the animation after migration can match the somatotype of the first object. Specific processing of each part is as follows:

The model definition includes defining a model information, a topology definition, joint matching, pose matching, and a collider definition of the second object and the first object.

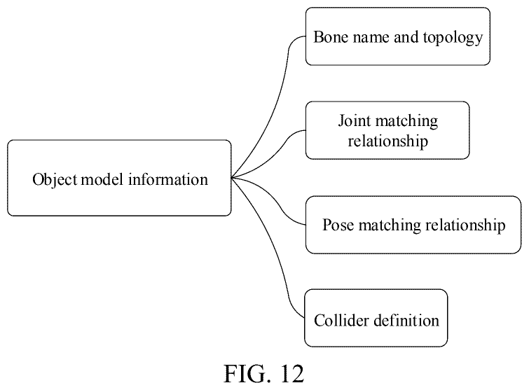

Defining model information of the second object and the first object: A model definition module defines model information of the second object and the first object based on settings of the user, where the information includes a topology, a joint matching relationship, a rest pose, and a collider, as shown in FIG. 12.

Topology definition: The system automatically obtains a model skeleton name and a hierarchical relationship from the animation or model file, as shown in FIG. 7.

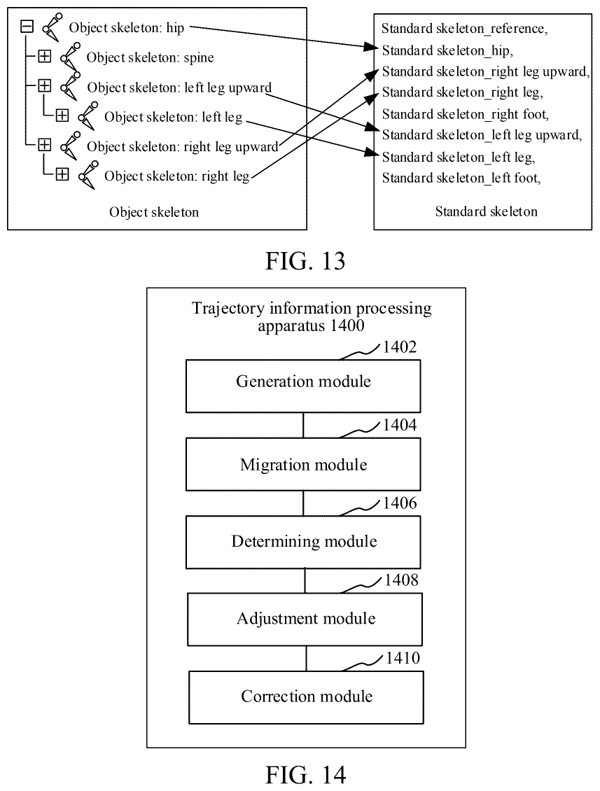

Joint matching: In this operation, a correspondence between a model skeleton and an internal skeleton is determined, and needs to be manually set by the user. FIG. 13 shows matching between some bones. The internal skeleton is a standard skeleton defined in a retargeting system, and includes main joints necessary for driving an object, such as limbs, a spine, and a head. An algorithm in the system is performed based on the internal skeleton. Therefore, a matching relationship between the model and the internal skeleton, that is, a matching relationship between an object skeleton and the standard skeleton, needs to be defined in advance. The object skeleton may be a skeleton of the first object or a skeleton of the second object.

Pose matching, namely, rest pose matching: The system determines rest poses of the second object and the first object. The rest poses of the two objects need to be consistent in poses, for example, hands are parallel to the ground, as shown in FIG. 10.

Collider definition, namely, generation of a local geometry: In this part, the system automatically calculates a minimum wrapping geometry, that is, a local geometry, of each joint of the first object, and the local geometries form a candidate geometry. A candidate geometry is generated in each iteration, an object geometry is determined in the candidate geometries generated in the iterations, and the object geometry is configured for subsequent collision detection and action optimization.

A process of generating the object geometry: Each joint of the first object is traversed to selects a vertex whose skinning weight is greater than 0.3. The vertex is a skinning key point. Principal component analysis is performed on a set formed by the vertexes, an axis corresponding to a first principal component is selected as a direction of the collider, and a size of the collider is adjusted based on an optimization problem. An optimization variable is a geometric feature of the collider. For example, a geometric feature of a capsule is a length and a radius, and a geometric feature of a sphere is a radius. An objective to be optimized in the optimization problem is to solve a candidate geometry having a smallest volume, and all vertexes of the first object are included in the candidate geometry. In other words, a candidate geometry having a smallest volume and including all the vertexes of the first object is used as the object geometry. For an example of a construction result of the object geometry, refer to FIG. 3.

Animation migration, namely, object trajectory migration: Joint rotation information and global translation information of the source animation stream are migrated. The global translation information includes trajectory information of limbs. After the migration, an animation stream migrated to the first object may be initially obtained, and a rotation degree of each joint keeps consistency with the source animation stream, but there is a quality problem such as model interpenetration. The quality problem is then to be resolved through the upper limb correction. The animation stream is the object trajectory information.

Upper limb correction: In this part, the body shape feature of the first object, namely, the object geometry constructed in the model definition model, is considered, to further optimize quality of an animation stream of the first object, and avoid problems such as the model interpenetration.

In this part, a Jacobian inverse kinematics (IK) problem is constructed to avoid collision between the limbs of the first object. The Jacobian matrix is a matrix that arranges first-order partial derivatives of a function in a specific pattern. A function is denoted as f: Rⁿ→R^{m}, and a Jacobian matrix of the function is:

$$J = [ \frac{\partial f}{\partial {x}_{1}} … \frac{\partial f}{\partial {x}_{n}} ] = [ \begin{matrix}\frac{\partial {f}_{1}}{\partial {x}_{1}} & … & \frac{\partial {f}_{1}}{\partial {x}_{n}} & \\ ⋮ & ⋱ & & ⋮ \\ ⋮ & & & \\ \frac{\partial {f}_{m}}{\partial {x}_{1}} & … & \frac{\partial {f}_{m}}{\partial {x}_{n}} & \end{matrix} ]$$

f in the Jacobian matrix is a distance between a collision occurrence position of a collision point and a corresponding collision avoidance position. x₁ . . . xₙ are a plurality of joint rotation components, for example, a joint rotation component corresponding to an x-axis, a joint rotation component corresponding to a y-axis, and a joint rotation component corresponding to a z-axis.

For example, P (corresponding to the local geometry i) in FIG. 8 corresponds to a row of data in the Jacobian matrix, and Q (corresponding to the local geometry j) corresponds to a row of data in the Jacobian matrix. In a similar manner, data of all collided local geometries is constructed as elements in the Jacobian matrix, and by solving the Jacobian matrix, joint rotation components of each joint corresponding to the x-axis, the y-axis, and the z-axis can be obtained, that is, a rotation amount corresponding to each joint can be obtained.

The Jacobian matrix is constructed, and a joint offset amount of each part is adjusted based on the Jacobian matrix, so that a collision point on each pair of joint colliders reaches a collision avoidance position specified by the system, to ensure that collision does not occur at the corresponding part. The joint offset amount of each part is a rotation change amount or increment of an upper limb joint (such as a clavicle, a shoulder, an elbow, a wrist, or a spine). Specifically, rotation represents rotation in a parent joint coordinate system, and a Euler angle is used for representation. An independent variable of a target function is a joint offset of each part, and a dependent variable is a distance between a collision occurrence position and a collision avoidance position of the collision point.

Processes of calculating a collision avoidance position of a collision point of a joint and solving a Jacobian IK are respectively described below, including calculation of the collision avoidance position of the collision point and solving of the Jacobian IK.

Calculation of the collision avoidance position: collision occurrence positions respectively corresponding to a plurality of collision points at which local geometric joint colliders collide are obtained, and a collision avoidance position of each collision point is calculated based on the collision occurrence positions. A specific calculation manner is shown in FIG. 8 and the corresponding embodiment.

Solving of the Jacobian IK: By solving the Jacobian IK, joint offset amounts of parts that make the collision point closest to the collision avoidance position are calculated. After the animation stream of the first object output in the animation migration process is corrected by using the joint offset amounts of the parts, the animation stream of the first object without collision after output can be obtained. The optimization process is iterative optimization, and a default maximum number of iterations is 20. Nis denoted as a quantity of joints, M is denoted as a quantity of collision avoidance positions, and update of an optimization variable X in each iteration is shown in the following formula:

$$X = {X}_{0} - {( {J}^{T} J + Damp * I )}^{- 1} * ( {J}^{T} * D + Damp * {X}_{0} )$$

X is an updated set of joint offset amounts of the parts. J is an element of a j^{th} column of an i^{th} row of a Jacobian matrix with a size of M*N, and represents a partial derivative of an i^{th} collision avoidance position with respect to a j^{th} joint rotation component. Damp is a damping parameter. A larger value indicates a more stable optimization process, but more iterations are needed for convergence. A default value of the damping parameter is 1000, and may be adjusted by the user based on a requirement. D is a matrix with a size of M*1 formed by arranging loss function values. In other words, D is a matrix formed by distances between the collision occurrence positions of the collision points and the corresponding collision avoidance positions. X₀ represents an optimization variable result of a previous iteration, that is, a set of updated joint offset amounts of the parts in the previous iteration. I is a unit matrix.

In this embodiment, a body shape feature of an object to which the limb animation needs to be migrated is considered, the limb animation migration without a model interpenetration defect can be performed in a real-time animation stream, and is applicable to a human-type object of any skeleton topology and shape, to match objects of different somatotypes. In addition, the geometry is constructed for the first object, and the Jacobian IK is solved, to avoid collision between geometries and effectively resolve the quality problem such as model interpenetration.

In this embodiment, a complete and independent retargeting procedure is established, does not rely on any large game engine or 3D software, and can be conveniently integrated into various procedures for driving different objects in real time, so that an application has a wider coverage.

The steps in the flowcharts involved in the foregoing embodiments are displayed in sequence based on indication of arrows, but the steps are not necessarily performed sequentially according to a sequence indicated by the arrows. Unless otherwise explicitly specified in this specification, execution of the steps is not strictly limited, and the steps may be performed in other sequences. Moreover, at least some of the steps in each embodiment may include a plurality of steps or a plurality of stages. The steps or stages are not necessarily performed at the same moment but may be performed at different moments. Execution of the steps or stages is not necessarily sequentially performed, but may be performed alternately with other steps or at least some of steps or stages of other steps.

Based on a same inventive concept, an embodiment of the present disclosure further provides a trajectory information processing apparatus configured to implement the trajectory information processing method related above. An implementation solution to the problem provided by the apparatus is similar to the implementation solution recorded in the foregoing method. Therefore, for specific limitations in one or more trajectory information processing apparatus embodiments provided below, reference may be made to the limitations on the foregoing trajectory information processing method. Details are not described herein again.

In an embodiment, as shown in FIG. 14, a trajectory information processing apparatus is provided, including:

a generation module 1402, configured to obtain a body shape feature of a first object, and generate an object geometry of the first object based on the body shape feature, the object geometry including a plurality of local geometries, and the local geometries surrounding at least one part of the first object;

a migration module 1404, configured to obtain object trajectory information of a second object, and migrate the object trajectory information of the second object to the object geometry, to obtain object trajectory information of the object geometry;

a determining module 1406, configured to determine a plurality of collision points at which the local geometries collide during interaction, and determine respective collision occurrence positions of the plurality of collision points;

an adjustment module 1408, configured to perform position adjustment on the plurality of collision occurrence positions, to obtain the respective collision avoidance positions of the plurality of collision points, the collision avoidance positions being configured for avoiding collision of the plurality of local geometries during the interaction; and

a correction module 1410, configured to correct object trajectory information of the object geometry based on the collision occurrence positions and the collision avoidance positions, to obtain object trajectory information of the first object.

In this embodiment, the body shape feature of the first object is obtained, and the object geometry of the first object is generated based on the body shape feature. The object geometry includes the plurality of local geometries, and the local geometries surround the local geometry of at least one part of the first object, so that the local geometry surrounding the part can fit the part, thereby enabling a generated object geometry to better fit the somatotype of the first object. The object trajectory information of the second object is obtained, and the object trajectory information of the second object is migrated to the object geometry, to obtain the object trajectory information of the object geometry, to preliminarily migrate the object trajectory information of the second object to the first object for subsequent adjustment. The plurality of collision points at which the local geometries of the object geometry collide during the interaction are determined, and the positions of the plurality of collision points, namely, the collision occurrence positions, are determined, to determine the position at which the local geometries collide during the interaction. The position adjustment is performed on the plurality of collision occurrence positions, to obtain the plurality of collision avoidance positions for avoiding the collision of the plurality of local geometries during the interaction, so that when the collision points are at the respective collision avoidance positions, the plurality of local geometries do not collide during the interaction. The object trajectory information of the object geometry is corrected based on the collision occurrence positions and the collision avoidance positions, so that after the correction, the parts of the first object do not collide during the interaction, to obtain the object trajectory information matching a somatotype characteristic of the first object. In addition, considering an impact of a somatotype of an object on migration of trajectory information, the migration of the trajectory information is more flexible and more accurate.

In an embodiment, the generation module 1402 is further configured to obtain respective skinning weights of the plurality of skinning key points; obtain a preset weight constraint condition and selecting, based on the skinning weights, the skinning key point satisfying the weight constraint condition; perform principal component analysis on the selected skinning key point, to obtain respective geometric axes of a plurality of parts of the first object; and for each part of the plurality of parts, generate, based on a geometric axis of the part, a local geometry surrounding the part, to obtain the object geometry formed by the local geometries.

In this embodiment, the body shape feature of the first object is represented by the skinning key point of the first object, the respective skinning weights of the plurality of skinning key points of the first object are obtained, to select the skinning key point satisfying the weight constraint condition based on the skinning weights, and perform the principal component analysis on the selected skinning key points, to obtain the respective geometric axes of the plurality of parts of the first object. In this way, features close to the geometric axis can be reserved, a feature dimension can be reduced, a calculation amount can be reduced, and the information loss can be reduced. In addition, as many features as possible of the part are reserved by using the geometric axis, and the reserved features can better present a shape of the part, so that the local geometry surrounding the part generated based on the geometric axis of the part can fit the part, and the object geometry formed by the obtained local geometries better fits the somatotype of the first object.

In an embodiment, the generation module 1402 is further configured to obtain a candidate geometric feature in each iteration, and for each iteration, generate a candidate geometry of the first object in the iteration based on the body shape feature and the candidate geometric feature of the iteration; determine a volume corresponding to the candidate geometry in each iteration; and obtain a preset volume constraint condition, select a volume satisfying the volume constraint condition from the volumes, and determine the candidate geometry corresponding to the selected volume as the object geometry.

In this embodiment, the candidate geometric feature in each iteration is obtained. For each iteration, the candidate geometry of the first object is generated in the iteration based on the body shape feature and the candidate geometric feature of the iteration, so that the candidate geometry of the first object can be generated respectively in different iterations by using different geometric features, to determine which geometric feature can best fit the somatotype of the first object. The volume corresponding to the candidate geometry in each iteration is determined, and a candidate geometry corresponding to a volume satisfying the volume constraint condition is selected from the volumes as the object geometry, so that a geometry that best fits the first object can be accurately selected based on the volume of the candidate geometry. In addition, the volume constraint condition may be selecting a candidate geometry having a smallest volume, where the candidate geometry having the smallest volume best fits the somatotype of the first object, to obtain a geometry that can accurately represent the somatotype of the first object.

In an embodiment, the generation module 1402 is further configured to determine a key point belonging to the first object in the candidate geometry in each iteration; obtain a preset key point constraint condition, and based on a key point belonging to the first object in each candidate geometry, select, from the candidate geometry obtained in each iteration, the candidate geometry having the key point satisfying the key point constraint condition; determine a volume corresponding to each selected candidate geometry.

In this embodiment, in each iteration, the key point belonging to the first object in the candidate geometry is determined, the preset key point constraint condition is obtained, and the candidate geometry having the key point satisfying the key point constraint condition is selected from the candidate geometry obtained in each iteration based on the key point belonging to the first object in each candidate geometry, so that the candidate geometry that conforms to a key point constraint can be preliminarily selected. Next, the volume corresponding to each candidate geometry satisfying the key point constraint condition is determined, thereby further selecting, from the volumes, the candidate geometry corresponding to the volume satisfying the volume constraint condition. In this way, the selected candidate geometry best fits the somatotype of the first object, so that model interpenetration caused by a difference between somatotypes of the character before and after migration is effectively avoided.

In an embodiment, the migration module 1404 is further configured to obtain a first bone hierarchical relationship of the first object, the first bone hierarchical relationship representing a hierarchical relationship among first bones of the first object; obtain a second bone hierarchical relationship of the second object, the second bone hierarchical relationship representing a hierarchical relationship among second bones of the second object; perform hierarchical matching on the first bone hierarchical relationship and the second bone hierarchical relationship to obtain a one-to-one matching relationship between the first bones and the second bones; and migrate the object trajectory information of the second object to the object geometry based on the matching relationship, to obtain the object trajectory information of the object geometry.

In this embodiment, the first bone hierarchical relationship represents the hierarchical relationship between the first bones of the first object, the second bone hierarchical relationship represents the hierarchical relationship between the second bones of the second object. The hierarchical matching is performed on the first bone hierarchical relationship of the first object and the second bone hierarchical relationship of the second object, to obtain the one-to-one matching relationship between the first bones and the second bones. In this way, each bone of the second object can be mapped to a bone of the first object, so that based on a matching relationship between bones, the object trajectory information of the second object is migrated to the object geometry, to obtain the object trajectory information of the object geometry.

In an embodiment, the migration module 1404 is further configured to obtain a standard bone hierarchical relationship of a standard skeleton, the standard bone hierarchical relationship representing a hierarchical relationship among standard bones of the standard skeleton; perform hierarchical mapping on the first bone hierarchical relationship and the standard bone hierarchical relationship, to obtain a one-to-one mapping relationship between the first bones and the standard bones; perform hierarchical mapping on the second bone hierarchical relationship and the standard bone hierarchical relationship, to obtain a one-to-one mapping relationship between the second bones and the standard bones; and construct, for each standard bone, a matching relationship between the first bone and the second bone that have the mapping relationship with the standard bone.

In this embodiment, the standard skeleton is formed by bones of the parts of the object, and the standard bone hierarchical relationship represents a hierarchical relationship between the standard bones of the standard skeleton. The standard skeleton and the standard bone hierarchical relationship are both preconfigured. Based on the first bone hierarchical relationship and the standard bone hierarchical relationship, the one-to-one mapping relationship between the first bones and the standard bones is constructed. Based on the second bone hierarchical relationship and the standard bone hierarchical relationship, the one-to-one mapping relationship between the second bones and the standard bones is constructed. In this way, the first bones of the first object and the second bones of the second object can be respectively mapped to the standard bones, so that the bones of the first object and the second object can be matched by using the standard bones, and bone matching between the first object and the second object is more accurate. This is beneficial to improving accuracy of subsequent trajectory information migration.

In an embodiment, the adjustment module 1408 is further configured to perform collision detection based on the collision occurrence positions of the plurality of collision points, to obtain collision depths and collision normal vectors between the plurality of collision points; and perform position adjustment based on the collision occurrence positions, the collision depths, and the collision normal vectors, to the obtain respective collision avoidance positions of the plurality of collision points.

In this embodiment, collision detection is performed based on the respective collision occurrence positions of the plurality of collision points, and the collision depth and the collision normal vector between the plurality of collision points can be accurately calculated, so that a collision degree between the collision points can be accurately reflected by using the collision depths. The position adjustment is performed based on the collision occurrence position, the collision depth, and the collision normal vector, to adjust the collision point to a position at which collision does not occur, so that the collision avoidance positions of the plurality of collision points can be obtained, thereby effectively avoiding collision caused during the interaction between the parts of the first object when the collision point is at the collision avoidance position.

In an embodiment, the adjustment module 1408 is further configured to obtain respective weight parameters of the plurality of local geometries; and for each collision point, perform position adjustment based on the collision occurrence position of the collision point, the weight parameter corresponding to the local geometry to which the collision point belongs, the collision depth, and the collision normal vector, to obtain the collision avoidance position of the collision point.

In this embodiment, the respective weight parameters of the plurality of local geometries are obtained, and a local geometry more inclined to be moved is reflected by using the weight parameter, so that for each collision point, the position adjustment is performed based on the collision occurrence position of the collision point, the weight parameter of the local geometry to which the collision point belongs, the collision depth, and the collision normal vector, to adjust the collision point to a position at which collision does not occur, thereby obtaining the respective collision avoidance positions of the plurality of collision points, and enabling the collision point to be located at the collision avoidance position, to effectively avoid collision caused by interaction of the parts of the first object. In addition, the weight parameter can reflect a position of a local geometry that is more adjusted and a position of a local geometry that is less adjusted, so that the local geometries can be adjusted in a most proper manner.

In an embodiment, the correction module 1410 is further configured to perform pose offset prediction based on the collision occurrence positions and the collision avoidance positions, to obtain pose offset information between the plurality of local geometries; and correct the object trajectory information of the object geometry based on the pose offset information, to obtain the object trajectory information of the first object.

In this embodiment, pose offset prediction is performed based on the collision occurrence positions and the collision avoidance positions, to calculate pose difference information when a local geometry to which each collision point belongs to is at the collision occurrence position and the corresponding collision avoidance position, to accurately obtain pose offset information between the plurality of local geometries. Based on the pose offset information, the object trajectory information of the object geometry is corrected, so that the trajectory information of each of the parts that collide during the interaction can be adjusted, to obtain the trajectory information of the parts that do not collide during the interaction. In this way, trajectory information of objects of different somatotypes can be accurately migrated, and the migrated trajectory information can completely conform to the object, to improve accuracy of trajectory migration.

In an embodiment, the correction module 1410 is further configured to obtain initial offset information, and pre-correct the object trajectory information of the object geometry based on the initial offset information, to obtain pre-corrected trajectory information, the pre-corrected trajectory information including predicted avoidance positions respectively corresponding to the plurality of collision points; determine, for each collision point, a distance between the predicted avoidance position and the collision avoidance position of the collision point; adjust the initial offset information based on the distance, to obtain updated offset information; and enter a next iteration, determine the updated offset information as initial offset information in the next iteration, perform the operation of pre-correcting the object trajectory information of the object geometry based on the initial offset information, and repeat the operations until an iteration end condition is satisfied, to obtain the pose offset information.

In this embodiment, the initial offset information is obtained, and the object trajectory information of the object geometry is pre-corrected based on the initial offset information, to predict the predicted avoidance positions respectively corresponding to the plurality of collision points. A distance difference between a predicted avoidance position and a collision avoidance position of each collision point is determined, so that a difference between the avoidance position obtained through correction and the collision avoidance position can be reflected based on a distance between the avoidance position obtained through prediction based on the initial offset information and the real collision avoidance position. In this way, the initial offset information is adjusted based on the distance difference, so that an avoidance position obtained by using updated offset information obtained in each iterative adjustment is closer to the real collision avoidance position. A next iteration is entered, and the updated offset information is determined as initial offset information in the next iteration. The operation of pre-correcting the object trajectory information of the object geometry based on the initial offset information continues to be performed. The operations are repeated until the iteration end condition is satisfied, to obtain the pose offset information. Therefore, the predicted avoidance position can continuously approach the real collision avoidance position in a plurality of iterations, so that migration of the trajectory information is more accurate.

In an embodiment, the object trajectory information of the object geometry includes limb trajectory information of each of at least two first limbs of the first object and joint rotation information of each of at least two parts of the first object, the object trajectory information of the second object includes limb trajectory information of each of at least two second limbs of the second object and joint rotation information of each of at least two parts of the second object, and the at least two first limbs of the first object and the at least two second limbs of the second object are in a one-to-one correspondence.

The apparatus further includes a constraint information determining module. The constraint information determining module is configured to determine first interaction information between the at least two first limbs based on the limb trajectory information of each of the at least two first limbs of the first object; determine second interaction information between the at least two second limbs based on the limb trajectory information of each of the at least two second limbs of the second object; and determine joint-chain interaction constraint information between the first object and the second object based on the first interaction information and the second interaction information.

The correction module 1410 is further configured to correct the limb trajectory information of the plurality of first limbs based on the joint-chain interaction constraint information, and correct the joint rotation information of the at least two parts of the first object based on the collision occurrence positions and the collision avoidance positions, to obtain the object trajectory information of the first object.

In this embodiment, the first interaction information between the at least two first limbs is determined, the second interaction information between the second limbs is determined, and the limb interaction constraint information between the first object and the second object is generated based on the first interaction information and the second interaction information. The generated limb interaction constraint information enables the plurality of first limbs to obtain the interaction relationship between the plurality of second limbs. The limb trajectory information of the plurality of first limbs is corrected based on the limb interaction constraint information, so that the migrated limb trajectory information retains the interaction relationship between the plurality of second limbs, and conforms to features of the limbs of the first object. The joint rotation information of the plurality of first limbs is corrected based on the collision occurrence positions and the collision avoidance positions, so that the joint rotation information in the object trajectory information migrated to the first object better fits the somatotype of the first object, to avoid model interpenetration generated after migration due to a large difference between the somatotypes of the second object and the first object.

In an embodiment, the constraint information determining module is further configured to pre-correct the limb trajectory information of each of the at least two second limbs of the second object, to obtain pre-corrected limb trajectory information of each of the at least two second limbs; and determine the second interaction information between the at least two second limbs based on the pre-corrected limb trajectory information of each of the at least two second limbs.

In this embodiment, the limb trajectory information of each of the at least two second limbs of the second object is pre-corrected, to obtain the pre-corrected limb trajectory information of each of the at least two second limbs. The second interaction information between the at least two second limbs is determined based on the pre-corrected limb trajectory information of each of the at least two second limbs, and the interaction relationship between the second limbs after the pre-correction can be pre-estimated.

In an embodiment, the constraint information determining module is further configured to determine first pose information of each of the at least two first limbs based on the limb trajectory information of each of the at least two first limbs of the first object; determine second pose information of each of the at least two second limbs based on the limb trajectory information of each of the at least two second limbs of the second object; and determine, for each first limb, single-joint-chain constraint information between the first limb and a corresponding second limb based on the first pose information of the first limb and the second pose information of the corresponding second limb.

The correction module 1410 is further configured to correct, for each first limb, the limb trajectory information of the first limb based on the limb interaction constraint information and single-limb constraint information between the first limb and a corresponding second limb.

In this embodiment, the first pose information of each of the plurality of first limbs of the first object and the second pose information of each of the plurality of second limbs of the second object are obtained. For each first limb, the single-limb constraint information between the first limb and the corresponding second limb is generated based on the first pose information of the first limb and the second pose information of the corresponding second limb. The generated single-limb constraint information enables the first limb to obtain the pose information of the second limb. For each first limb, the limb trajectory information of the first limb is corrected based on the joint-chain interaction constraint information and the single-limb constraint information between the first limb and the second limb, so that the first limbs of the first object can obtain a pose consistent with a pose of the corresponding second limbs of the second object, and interaction between the limbs of the second object also remains consistent with interaction between the limbs of the first object. In this way, migration of the trajectory information is more accurate.

In an embodiment, the first limb includes a first joint chain, the first joint chain is formed by connecting a plurality of joints and parts between the plurality of joints of the first object, the second limb includes a second joint chain, the second joint chain is formed by connecting a plurality of joints and parts between the plurality of joints of the second object, the single-limb constraint information is constraint information between the first joint chain and the second joint chain, the limb interaction constraint information is constraint information between the first interaction relationship and the second interaction relationship, the first interaction relationship is the interaction relationship between the at least two first joint chains, and the second interaction relationship is the interaction relationship between the at least two second joint chains.

In this embodiment, the first pose information of each of the plurality of first limbs of the first object and the second pose information of each of the plurality of second limbs of the second object are obtained. For each first limb, the single-limb constraint information between the first limb and the corresponding second limb is generated based on the first pose information of the first limb and the second pose information of the corresponding second limb. The generated single-limb constraint information enables the first limb to obtain the pose information of the second limb. For each first limb, the limb trajectory information of the first limb is corrected based on the joint-chain interaction constraint information and the single-limb constraint information between the first limb and the second limb, so that the first limbs of the first object can obtain a pose consistent with a pose of the corresponding second limbs of the second object, and interaction between the limbs of the second object also remains consistent with interaction between the limbs of the first object. In this way, migration of the trajectory information is more accurate.

All or some of the modules in the trajectory information processing apparatus may be implemented by software, hardware, and a combination thereof. The modules may be built in or independent of a processor of a computer device in a form of hardware, or may be stored in a memory of a computer device in a form of software, so that the processor can invoke and execute operations corresponding to the modules.

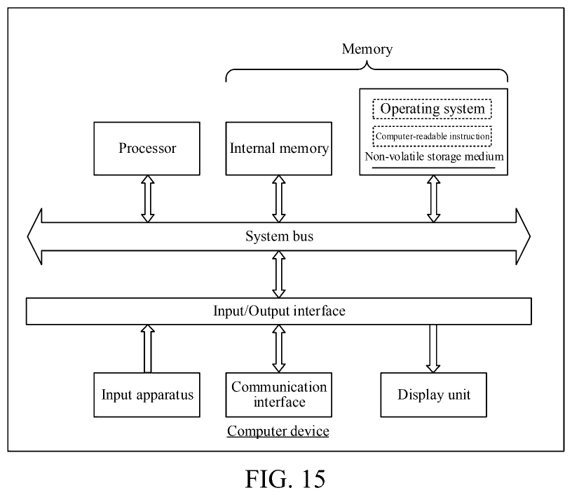

In an embodiment, a computer device is provided. The computer device may be a terminal or a server. Using a terminal as an example, a diagram of an internal structure of the terminal may be shown in FIG. 15. The computer device includes a processor, a memory, an input/output interface, a communication interface, a display unit, and an input apparatus. The processor, the memory, and the input/output interface are connected to each other by using a system bus, and the communication interface, the display unit, and the input apparatus are connected to the system bus by using the input/output interface. The processor of the computer device is configured to provide computation and control capabilities. The memory of the computer device includes a non-volatile storage medium and an internal memory. The non-volatile storage medium has an operating system and computer-readable instructions stored therein. The internal memory provides an environment for running the operating system and the computer-readable instructions in the non-volatile storage medium. The input/output interface of the computer device is configured to exchange information between the processor and the external device. The communication interface of the computer device is configured to communicate with an external terminal in a wired or wireless manner. The wireless manner may be implemented through Wi-Fi, a mobile cellular network, near field communication (NFC), or another technology. The computer-readable instructions are executed by the processor to implement a trajectory information processing method. The display unit of the computer device may be configured to form a visually visible picture and may be a display screen, a projection apparatus, or a virtual reality imaging apparatus. The display screen may be a liquid crystal display screen or an e-ink display screen. The input apparatus of the computer device may be a touch layer covering the display screen, or may be a button, a trackball, or a touchpad disposed on a housing of the computer device, or may be an external keyboard, touchpad, a mouse or the like.

A person skilled in the art may understand that, the structure shown in FIG. 15 is merely a block diagram of a part of a structure related to the solution of the present disclosure and does not limit the computer device to which the solution of the present disclosure is applied. Specifically, the computer device may include more or fewer components than those in the drawings, or some components are combined, or a different component deployment is used.

In an embodiment, a computer device is further provided, including a memory and a processor, the memory has computer-readable instructions stored therein, the processor, when executing the computer-readable instructions, implementing the steps in the foregoing method embodiments.

In an embodiment, a computer-readable storage medium is provided, having computer-readable instructions stored therein. When the computer-readable instructions are executed by a processor, the steps in the foregoing method embodiments are implemented.

In an embodiment, a computer program product is provided, including computer-readable instructions. The computer-readable instructions, when executed by a processor, the steps in the foregoing method embodiments are implemented.

User information (including, but not limited to, information about user equipment, user personal information, and the like) and data (including, but not limited to, data for analysis, stored data, displayed data, and the like) involved in the present disclosure are all information and data authorized by a user or fully authorized by all parties, and collection, use, and processing of relevant data need to comply with relevant laws, regulations, and standards of relevant countries and regions.

A person of ordinary skill in the art may understand that all or some of the procedures of the methods in the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. References to the memory, the database, or another medium used in the embodiments provided in the present disclosure may all include at least one of a non-volatile or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, and the like. The volatile memory may include a random access memory (RAM) and an external cache. For the purpose of illustration but not limitation, the RAM is available in many forms, such as a static random access memory (SRAM) or a dynamic random access memory (DRAM). The databases involved in the embodiments provided in the present disclosure may include at least one of a relational database and a non-relational database. The non-relational database may include, but is not limited to, a blockchain-based distributed database and the like. The processors involved in the various embodiments provided in the present disclosure may be a general-purpose processor, a central processing unit, a graphics processing unit, a digital signal processor, a programmable logic device, a data processing logic device based on quantum computing, and are not limited thereto.

The technical features in the foregoing embodiments may be combined in different manners to form other embodiments. For concise description, not all possible combinations of the technical features in the embodiments are described. However, the combinations of the technical features shall all be considered as falling within the scope recorded by this specification provided that no conflict exists.

The foregoing embodiments only describe several implementations of the present disclosure, which are described specifically and in detail, but cannot be construed as a limitation to the patent scope of the present disclosure. A person of ordinary skill in the art may further make several variations and improvements without departing from the ideas of the present disclosure, and such variations and improvements all fall within the protection scope of the present disclosure. Therefore, the protection scope of the present disclosure shall be subject to the appended claims.

What is claimed is:

1. A trajectory information processing method, performed by a computer device, the method comprising:
obtaining a body shape feature of a first object, and generating an object geometry of the first object based on the body shape feature, the object geometry comprising a plurality of local geometries, and each of the local geometries surrounding at least one part of the first object;
obtaining object trajectory information of a second object, and migrating the object trajectory information of the second object to the object geometry, to obtain object trajectory information of the object geometry;
determining a plurality of collision points at which the local geometries collide during interaction with each other, and determining respective collision occurrence positions of the plurality of collision points;
performing position adjustment on the plurality of collision occurrence positions, to obtain respective collision avoidance positions of the plurality of collision points, wherein when the collision points are located at respective collision avoidance positions, the plurality of local geometries do not collide during the interaction; and
correcting the object trajectory information of the object geometry based on the collision occurrence positions and the collision avoidance positions, to obtain object trajectory information of the first object.

2. The method according to claim 1, wherein the body shape feature is represented by a plurality of skinning key points of the first object, and the generating an object geometry of the first object based on the body shape feature comprises:
obtaining respective skinning weights of the plurality of skinning key points;
obtaining a preset weight constraint condition and selecting, based on the skinning weights, the skinning key point satisfying the weight constraint condition;
performing principal component analysis on the selected skinning key point, to obtain respective geometric axes of a plurality of parts of the first object; and
for a part of the plurality of parts, generating, based on a geometric axis of the part, a local geometry surrounding the part, to obtain the object geometry formed by the local geometries.

3. The method according to claim 1, wherein the generating an object geometry of the first object based on the body shape feature comprises:
obtaining a candidate geometric feature in each iteration, and for each iteration, generating a candidate geometry of the first object in the iteration based on the body shape feature and the candidate geometric feature of the iteration;
determining a volume corresponding to the candidate geometry in each iteration; and
obtaining a preset volume constraint condition, selecting a volume satisfying the volume constraint condition from the volumes, and determining the candidate geometry corresponding to the selected volume as the object geometry.

4. The method according to claim 3, wherein the body shape feature is represented by a plurality of key points of the first object, and the determining a volume corresponding to the candidate geometry in each iteration comprises:
determining, in each iteration, a key point belonging to the first object in the candidate geometry;
obtaining a preset key point constraint condition, and based on the key point belonging to the first object in each candidate geometry, selecting, from the candidate geometry obtained in each iteration, the candidate geometry having the key point satisfying the key point constraint condition; and
determining a volume corresponding to each selected candidate geometry.

5. The method according to claim 1, wherein the migrating the object trajectory information of the second object to the object geometry, to obtain object trajectory information of the object geometry comprises:
obtaining a first bone hierarchical relationship among first bones of the first object;
obtaining a second bone hierarchical relationship among second bones of the second object;
performing hierarchical matching on the first bone hierarchical relationship and the second bone hierarchical relationship to obtain a one-to-one matching relationship between the first bones and the second bones; and
migrating the object trajectory information of the second object to the object geometry based on the matching relationship, to obtain the object trajectory information of the object geometry.

6. The method according to claim 5, wherein the performing hierarchical matching on the first bone hierarchical relationship and the second bone hierarchical relationship to obtain a one-to-one matching relationship between the first bones and the second bones comprises:
obtaining a standard bone hierarchical relationship among standard bones of the standard skeleton;
performing hierarchical mapping on the first bone hierarchical relationship and the standard bone hierarchical relationship, to obtain a one-to-one mapping relationship between the first bones and the standard bones;
performing hierarchical mapping on the second bone hierarchical relationship and the standard bone hierarchical relationship, to obtain a one-to-one mapping relationship between the second bones and the standard bones; and
constructing, for a standard bone, a matching relationship between the first bone and the second bone that have the mapping relationship with the standard bone.

7. The method according to claim 1, wherein the performing position adjustment on the plurality of collision occurrence positions, to obtain collision avoidance positions of the plurality of collision points comprises:
performing collision detection based on the collision occurrence positions of the plurality of collision points, to obtain collision depths and collision normal vectors between the plurality of collision points; and
performing position adjustment based on the collision occurrence positions, the collision depths, and the collision normal vectors, to obtain the respective collision avoidance positions of the plurality of collision points.

8. The method according to claim 7, wherein the performing position adjustment based on the collision occurrence positions, the collision depths, and the collision normal vectors, to obtain the respective collision avoidance positions of the plurality of collision points comprises:
obtaining respective weight parameters of the plurality of local geometries; and
for a collision point, performing position adjustment based on the collision occurrence position of the collision point, the weight parameter of the local geometry to which the collision point belongs, the collision depth, and the collision normal vector, to obtain the collision avoidance position of the collision point.

9. The method according to claim 1, wherein the correcting the object trajectory information of the object geometry based on the collision occurrence positions and the collision avoidance positions, to obtain object trajectory information of the first object comprises:
performing pose offset prediction based on the collision occurrence positions and the collision avoidance positions, to obtain pose offset information between the plurality of local geometries; and
correcting the object trajectory information of the object geometry based on the pose offset information, to obtain the object trajectory information of the first object.

10. The method according to claim 9, wherein the performing pose offset prediction based on the collision occurrence positions and the collision avoidance positions, to obtain pose offset information between the plurality of local geometries comprises:
obtaining initial offset information, and pre-correcting the object trajectory information of the object geometry based on the initial offset information, to obtain pre-corrected trajectory information, the pre-corrected trajectory information comprising respective predicted avoidance positions of the plurality of collision points;
determining, for a collision point of the plurality of collision points, a distance between the predicted avoidance position and the collision avoidance position of the collision point;
adjusting the initial offset information based on the distance, to obtain updated offset information; and
entering a next iteration, determining the updated offset information as initial offset information in the next iteration, performing the operation of pre-correcting the object trajectory information of the object geometry based on the initial offset information, and repeating the operations until an iteration end condition is satisfied, to obtain the pose offset information.

11. The method according to claim 1, wherein the object trajectory information of the object geometry comprises limb trajectory information of each of at least two first limbs of the first object and joint rotation information of each of at least two parts of the first object, the object trajectory information of the second object comprises limb trajectory information of each of at least two second limbs of the second object and joint rotation information of each of at least two parts of the second object, and the at least two first limbs of the first object and the at least two second limbs of the second object are in a one-to-one correspondence; the method further comprises:
determining first interaction information between the at least two first limbs based on the limb trajectory information of each of the at least two first limbs of the first object;
determining second interaction information between the at least two second limbs based on the limb trajectory information of each of the at least two second limbs of the second object; and
determining limb interaction constraint information between the first object and the second object based on the first interaction information and the second interaction information; and
the correcting the object trajectory information of the object geometry based on the collision occurrence positions and the collision avoidance positions, to obtain object trajectory information of the first object comprises:
correcting the limb trajectory information of the plurality of first limbs based on the limb interaction constraint information, and correcting the joint rotation information of the at least two parts of the first object based on the collision occurrence positions and the collision avoidance positions, to obtain the object trajectory information of the first object.

12. The method according to claim 11, wherein the determining second interaction information between the at least two second limbs based on the limb trajectory information of each of the at least two second limbs of the second object comprises:
pre-correcting the limb trajectory information of each of the at least two second limbs of the second object, to obtain pre-corrected limb trajectory information of each of the at least two second limbs; and
determining the second interaction information between the at least two second limbs based on the pre-corrected limb trajectory information of each of the at least two second limbs.

13. The method according to claim 11, further comprising:
determining first pose information of each of the at least two first limbs based on the limb trajectory information of each of the at least two first limbs of the first object;
determining second pose information of each of the at least two second limbs based on the limb trajectory information of each of the at least two second limbs of the second object;
determining, for a first limb, single-limb constraint information between the first limb and a corresponding second limb based on the first pose information of the first limb and the second pose information of the corresponding second limb; and
the correcting the limb trajectory information of the plurality of first limbs based on the limb interaction constraint information comprises:
correcting, for a first limb, the limb trajectory information of the first limb based on the limb interaction constraint information and single-limb constraint information between the first limb and a corresponding second limb.

14. The method according to claim 13, wherein the first limb comprises a first joint chain, the first joint chain is formed by connecting a plurality of joints of the first object and parts between the plurality of joints, the second limb comprises a second joint chain, the second joint chain is formed by connecting a plurality of joints of the second object and parts between the plurality of joints, the single-limb constraint information is constraint information between the first joint chain and the second joint chain, the limb interaction constraint information is constraint information between a first interaction relationship between at least two first joint chains and a second interaction relationship between at least two second joint chains.

15. A trajectory information processing apparatus, comprising:
a memory and a processor, the memory having computer-readable instructions stored therein, and the processor, when executing the computer-readable instructions, implementing:
obtaining a body shape feature of a first object, and generating an object geometry of the first object based on the body shape feature, the object geometry comprising a plurality of local geometries, and each of the local geometries surrounding at least one part of the first object;
obtaining object trajectory information of a second object, and migrating the object trajectory information of the second object to the object geometry, to obtain object trajectory information of the object geometry;
determining a plurality of collision points at which the local geometries collide during interaction with each other, and determining respective collision occurrence positions of the plurality of collision points;
performing position adjustment on the plurality of collision occurrence positions, to obtain respective collision avoidance positions of the plurality of collision points, wherein when the collision points are located at respective collision avoidance positions, the plurality of local geometries do not collide during the interaction; and
correcting the object trajectory information of the object geometry based on the collision occurrence positions and the collision avoidance positions, to obtain object trajectory information of the first object.

16. The apparatus according to claim 15, wherein the body shape feature is represented by a plurality of skinning key points of the first object, and the generating an object geometry of the first object based on the body shape feature comprises:
obtaining respective skinning weights of the plurality of skinning key points;
obtaining a preset weight constraint condition and selecting, based on the skinning weights, the skinning key point satisfying the weight constraint condition;
performing principal component analysis on the selected skinning key point, to obtain respective geometric axes of a plurality of parts of the first object; and
for a part of the plurality of parts, generating, based on a geometric axis of the part, a local geometry surrounding the part, to obtain the object geometry formed by the local geometries.

17. The apparatus according to claim 15, wherein the generating an object geometry of the first object based on the body shape feature comprises:
obtaining a candidate geometric feature in each iteration, and for each iteration, generating a candidate geometry of the first object in the iteration based on the body shape feature and the candidate geometric feature of the iteration;
determining a volume corresponding to the candidate geometry in each iteration; and
obtaining a preset volume constraint condition, selecting a volume satisfying the volume constraint condition from the volumes, and determining the candidate geometry corresponding to the selected volume as the object geometry.

18. The apparatus according to claim 17, wherein the body shape feature is represented by a plurality of key points of the first object, and the determining a volume corresponding to the candidate geometry in each iteration comprises:
determining, in each iteration, a key point belonging to the first object in the candidate geometry;
obtaining a preset key point constraint condition, and based on the key point belonging to the first object in each candidate geometry, selecting, from the candidate geometry obtained in each iteration, the candidate geometry having the key point satisfying the key point constraint condition; and
determining a volume corresponding to each selected candidate geometry.

19. The apparatus according to claim 15, wherein the migrating the object trajectory information of the second object to the object geometry, to obtain object trajectory information of the object geometry comprises:
obtaining a first bone hierarchical relationship among first bones of the first object;
obtaining a second bone hierarchical relationship among second bones of the second object;
performing hierarchical matching on the first bone hierarchical relationship and the second bone hierarchical relationship to obtain a one-to-one matching relationship between the first bones and the second bones; and
migrating the object trajectory information of the second object to the object geometry based on the matching relationship, to obtain the object trajectory information of the object geometry.

20. A non-transitory computer-readable storage medium, having computer-readable instructions stored therein, the computer-readable instructions, when executed by a processor, causing the processor to implement:
obtaining a body shape feature of a first object, and generating an object geometry of the first object based on the body shape feature, the object geometry comprising a plurality of local geometries, and each of the local geometries surrounding at least one part of the first object;
obtaining object trajectory information of a second object, and migrating the object trajectory information of the second object to the object geometry, to obtain object trajectory information of the object geometry;
determining a plurality of collision points at which the local geometries collide during interaction with each other, and determining respective collision occurrence positions of the plurality of collision points;
performing position adjustment on the plurality of collision occurrence positions, to obtain respective collision avoidance positions of the plurality of collision points, wherein when the collision points are located at respective collision avoidance positions, the plurality of local geometries do not collide during the interaction; and
correcting the object trajectory information of the object geometry based on the collision occurrence positions and the collision avoidance positions, to obtain object trajectory information of the first object.
